(19) United States
(12) Patent Application Publication
(10) Pub. No.: US 2019/0157715 A1
(43) Pub. Date: May 23, 2019

(54) SOLID ELECTROLYTE COMPOSITION, SOLID ELECTROLYTE-CONTAINING SHEET, ALL-SOLID STATE SECONDARY BATTERY, AND METHODS FOR MANUFACTURING SOLID ELECTROLYTE-CONTAINING SHEET AND ALL-SOLID STATE SECONDARY BATTERY

(71) Applicant: FUJIFILM Corporation, Tokyo (JP)

(72) Inventors: Masaomi MAKINO, Ashigarakami-gun (JP); Hiroaki MOCHIZUKI, Ashigarakami-gun (JP); Toshihiko YAWATA, Ashigarakami-gun (JP); Tomonori MIMURA, Ashigarakami-gun (JP)

(73) Assignee: FUJIFILM Corporation, Tokyo (JP)

(21) Appl. No.: 16/253,481

(22) Filed: Jan. 22, 2019

Related U.S. Application Data
(63) Continuation of application No. PCT/JP2017/026162, filed on Jul. 19, 2017.

(30) Foreign Application Priority Data
Jul. 22, 2016 (JP) 2016-144054

(51) Int. Cl. H01M 10/0562; H01M 10/0585; H01M 10/0525; H01M 4/13; H01M 4/62

(52) U.S. Cl. CPC H01M 10/0562; H01M 10/0585; H01M 2300/0068; H01M 4/13; H01M 4/62; H01M 10/0525

(57) ABSTRACT

Provided are a solid electrolyte composition containing an inorganic solid electrolyte, a specific fluorine-containing compound, and a dispersion medium, in which a content of the specific fluorine-containing compound in a total solid content of the solid electrolyte composition is 0.1% by mass or more and less than 20% by mass, a solid electrolyte-containing sheet having an inorganic solid electrolyte and a specific fluorine-containing compound, an all-solid state secondary battery, and methods for manufacturing a solid electrolyte-containing sheet and an all-solid state secondary battery.

### CROSS-REFERENCE TO RELATED APPLICATIONS

This application is a Continuation of PCT International Application No. PCT/JP2017/026162 filed on Jul. 19, 2017, which claims priority under 35 U.S.C. § 119 (a) to Japanese Patent Application No. 2016-144054 filed in Japan on Jul. 22, 2016. Each of the above applications is hereby expressly incorporated by reference, in its entirety, into the present application.

### BACKGROUND OF THE INVENTION

### 1. Field of the Invention

The present invention relates to a solid electrolyte composition, a solid electrolyte-containing sheet, an all-solid state secondary battery, and methods for manufacturing a solid electrolyte-containing sheet and an all-solid state secondary battery.

### 2. Description of the Related Art

A lithium ion secondary battery is a storage battery which has a negative electrode, a positive electrode, and an electrolyte sandwiched between the negative electrode and the positive electrode and enables charging and discharging by the reciprocal migration of lithium ions between both electrodes. In the related art, in lithium ion secondary batteries, an organic electrolytic solution has been used as the electrolyte. However, in organic electrolytic solutions, liquid leakage is likely to occur, there is a concern that a short circuit and ignition may be caused in batteries due to overcharging or overcharging, and there is a demand for additional improvement in safety and reliability.

Under such circumstances, all-solid state secondary batteries in which an inorganic solid electrolyte is used instead of the organic electrolytic solution are attracting attention. In all-solid state secondary batteries, all of the negative electrode, the electrolyte, and the positive electrode are solid, safety and reliability which are considered as a problem of batteries in which the organic electrolytic solution is used can be significantly improved, and it also becomes possible to extend the service lives. Furthermore, all-solid state secondary batteries can be provided with a structure in which the electrodes and the electrolyte are directly disposed in series. Therefore, it becomes possible to increase the energy density to be higher than that of secondary batteries in which the organic electrolytic solution is used, and the application to electric vehicles, large-sized storage batteries, and the like is anticipated.

Due to the respective advantages described above, development of all-solid state secondary batteries as next-generation lithium ion batteries and compositions and sheets for producing all-solid state secondary batteries is underway. For example, in order to improve the binding property among the solid particles of an active material, an inorganic solid electrolyte, and the like attributed to the expansion and contraction of the active material by charging and discharging, a binding material is used. JP2010-146823A describes a solid electrolyte composition formed by dispersing a solid electrolyte and a binding agent in a dispersion medium containing a fluorine-based solvent and a solid electrolyte sheet obtained by applying this composition. In addition, a slurry for an electrode for a solid battery containing a fluorine-based resin such as a fluorine-based copolymer including a vinylidene fluoride monomer unit as a binding material is described (JP2014-078400A and JP2014-007138A).

### SUMMARY OF THE INVENTION

In recent years, together with the progress of the development of all-solid state secondary batteries, a demand for the performance of the all-solid state secondary batteries such as the improvement of the battery voltage has been intensifying. Furthermore, there has been another demand for the improvement of the storage stability and handleability of a constituent material of a solid electrolyte layer or an electrode active material layer in an all-solid state secondary battery, the performance improvement of an all-solid state secondary battery produced using the above-described constituent material after being stored, and the like.

In JP2010-146823A, a solid electrolyte sheet which has excellent coating uniformity and is densified is obtained. However, the battery performance such as the battery voltage is not evaluated. In addition, JP2010-146823A, JP2014-078400A, and JP2014-007138A do not describe the storage stability of a solid electrolyte composition and a solid electrolyte-containing sheet and the battery performance of an all-solid state secondary battery produced using the solid electrolyte composition and/or the solid electrolyte-containing sheet after being stored.

In consideration of the above-described circumstances, an object of the present invention is to provide a solid electrolyte composition which has excellent storage stability and is capable of realizing a high battery voltage in an all-solid state secondary battery. In addition, another object of the present invention is to provide a solid electrolyte-containing sheet which is excellent in terms of the uniformity of the layer thickness and the storage stability, is capable of realizing a high battery voltage in an all-solid state secondary battery, and is capable of realizing a high battery voltage even in the case of being produced using the solid electrolyte-containing sheet after being stored. Furthermore, still another object of the present invention is to provide an all-solid state secondary battery having a high battery voltage.

In addition, far still another object of the present invention is to provide methods for manufacturing a solid electrolyte-containing sheet and an all-solid state secondary battery having the above-described excellent performance respectively.

The above-described objects were achieved by the following means.

<1> A solid electrolyte composition comprising: (A) an inorganic solid electrolyte having a conductivity of an ion of a metal belonging to Group I or II of the periodic table; (B) a fluorine-containing compound satisfying all of the following conditions b1 to b4; and (C) a dispersion medium, in which a content of the fluorine-containing compound (B) in a total solid content of the solid electrolyte composition is 0.1% by mass or more and less than 20% by mass.

b1: as constituent atoms, a carbon atom and a fluorine atom are included, but a silicon atom is not included.

b2: N_{F}/N_{ALL} that is a ratio of the number N_{F} of fluorine atoms to the number N_{ALL} of all atoms satisfies 0.10≤N_{F}/N_{ALL}≤0.80.

b3: a molecular weight is less than 5,000, which does not apply to a polymer.

b4: a boiling point at a normal pressure or an initiation temperature of thermal decomposition at a normal pressure exceeds 100° C.

<2> The solid electrolyte composition according to <1>, in which the fluorine-containing compound (B) is solid at a normal pressure and a normal temperature.

<3> The solid electrolyte composition according to <1> or <2>, in which the fluorine-containing compound (B) has an aromatic ring.

<4> The solid electrolyte composition according to any one of <1> to <3>, in which the fluorine-containing compound (B) is at least one selected from compounds represented by any of Formulae (1) to (3).

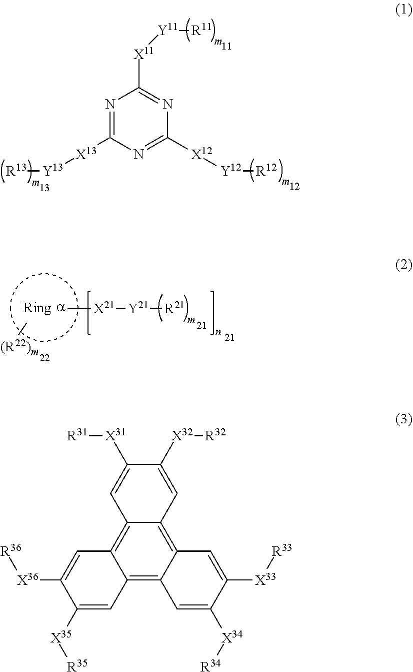

In Formula (1), R¹¹ to R¹³ each independently represent a fluorine-containing substituent or a hydrogen atom, X¹¹ to X¹³ each independently represent a single bond, an alkylene group, —O—, —S—, —C(═O)—, —NR—, or a divalent linking group formed of a combination thereof, Y¹¹ to Y¹³ each independently represent a single bond or an n-valent hydrocarbon group, and m₁₁ to m₁₃ each independently represent an integer of 1 to 5. Here, R represents a hydrogen atom, or an alkyl group, and n is m₁₁+1, m₁₂+1, or m₁₃+1. In a case in which there is a plurality of R¹¹'s, the plurality of R¹¹'s may be identical to or different from each other, in a case in which there is a plurality of R¹²'s, the plurality of R¹²'s may be identical to or different from each other, and, in a case in which there is a plurality of R¹³'s, the plurality of R¹³'s may be identical to or different from each other. Here, at least one of R¹¹ to R¹³ represents a fluorine-containing substituent.

In Formula (2), a ring α represents a benzene ring or a naphthalene ring. R²¹ represents a fluorine-containing substituent or a hydrogen atom, X²¹ represents a single bond, an alkylene group, —O—, —S—, —C(═O)—, —NR—, or a divalent linking group formed of a combination thereof, Y²¹ represents a single bond or an m₂₁+1-valent hydrocarbon group, m₂₁ represents an integer of 1 to 5, and n²¹ represents an integer of 1 to 8. Here, R represents a hydrogen atom or an alkyl group. R²² represents an organic group, and m₂₂ represents an integer of 0 to 7. In a case in which there is a plurality of R²¹'s, the plurality of R²¹'s may be identical to or different from each other, and, in a case in which there is a plurality of R²²'s, the plurality of R²²'s may be identical to or different from each other. Here, at least one of R²¹'s represents a fluorine-containing substituent.

In Formula (3), R³¹ to R³⁶ each independently represent a fluorine-containing substituent or a hydrogen atom, X³¹ to X³⁶ each independently represent a single bond, an alkylene group, —O—, —S—, —C(═O)—, —NR—, or a divalent linking group formed of a combination thereof. Here, R represents a hydrogen atom or an alkyl group. Here, at least one of R³¹ to R³⁶ represents a fluorine-containing substituent.

<5> The solid electrolyte composition according to <4>, in which the fluorine-containing substituent is a fluorine atom, a fluorine-substituted alkyl group, a fluorine-substituted alkoxy group, or a fluorine-substituted acyloxy group.

<6> The solid electrolyte composition according to any one of <1> to <5>, in which the dispersion medium (C) has a lower boiling point than the fluorine-containing compound (B).

<7> The solid electrolyte composition according to any one of <1> to <6>, in which the dispersion medium (C) is a hydrocarbon solvent.

<8> The solid electrolyte composition according to any one of <1> to <7>, further comprising: (D) a binder.

<9> The solid electrolyte composition according to <8>, in which the binder (D) is polymer particles having a volume-average particle diameter of 10 nm to 30 μm.

<10> The solid electrolyte composition according to any one of <1> to <9>, in which the inorganic solid electrolyte having a conductivity of an ion of a metal belonging to Group I or II of the periodic table is a sulfide-based inorganic solid electrolyte (A).

<11> A solid electrolyte-containing sheet comprising: (A) an inorganic solid electrolyte having a conductivity of an ion of a metal belonging to Group I or II of the periodic table; and (B) a fluorine-containing compound satisfying all of the following conditions b1 to b4.

b1: as constituent atoms, a carbon atom and a fluorine atom are included, but a silicon atom is not included.

b2: N_{F}/N_{ALL} that is a ratio of the number N_{F} of fluorine atoms to the number N_{ALL} of all atoms satisfies 0.10≤N_{F}/N_{ALL}≤0.80.

b3: a molecular weight is less than 5,000, which does not apply to a polymer.

b4: a boiling point at a normal pressure or an initiation temperature of thermal decomposition at a normal pressure exceeds 100° C.

<12> A method for manufacturing the solid electrolyte-containing sheet according to <11>, comprising: a step of applying a solid electrolyte composition containing (A) the inorganic solid electrolyte having a conductivity of an ion of a metal belonging to Group I or II of the periodic table; (B) the fluorine-containing compound; and (C) a dispersion medium onto a base material; and

a step of heating and drying the solid electrolyte composition.

<13> An all-solid state secondary battery comprising: a positive electrode active material layer; a negative electrode active material layer; and a solid electrolyte layer, in which at least one layer of the positive electrode active material layer; the negative electrode active material layer; and the solid electrolyte layer is the solid electrolyte-containing sheet according to <11 >.

<14> A method for manufacturing an all-solid state secondary battery, comprising: manufacturing an all-solid state secondary battery through the manufacturing method according to <12>.

In the present specification, numerical ranges expressed using “to” include numerical values before and after the “to” as the lower limit value and the upper limit value.

In the present specification, “acrylic” or “(meth)acrylic” that is simply expressed is used to refer to methacrylic and/or acrylic. In addition, “acryloyl” or “(meth)acryloyl” that is simply expressed is used to refer to methacryloyl and/or acryloyl.

In the present specification, “normal pressure” is 1,013 hPa (760 mmHg), and “normal temperature” is 25° C.

In the present specification, a mass-average molecular weight can be measured as a polystyrene-equivalent molecular weight by means of GPC unless particularly otherwise described. At this time, a GPC apparatus HLC-8220 (manufactured by Tosoh Corporation) is used, G3000HXL+G2000HXL is used as a column, a flow rate at 23° C. is 1 mL/min, and the molecular weight is detected by R1. An eluent can be selected from tetrahydrofuran (THF), chloroform, N-methyl-2-pyrrolidone (NMP), and m-cresol/chloroform (manufactured by Shonanwako Junyaku KK), and THF is used in a case in which a subject needs to be dissolved.

According to the present invention, the following effects are obtained. That is, the solid electrolyte composition of the embodiment of the invention has excellent storage stability and is capable of exhibiting a high battery voltage in an all-solid state secondary battery. The solid electrolyte-containing sheet of the embodiment of the invention is excellent in terms of the uniformity of the layer thickness, has excellent storage stability, exhibits a high battery voltage in an all-solid state secondary battery, suppresses the occurrence of short-circuit in an all-solid state secondary battery even in the case of producing the all-solid state secondary battery using the solid, electrolyte-containing sheet after being stored, and is capable of exhibiting a high battery voltage. The all-solid state secondary battery of the embodiment of the invention is capable of exhibiting a high battery voltage. More preferably, the solid electrolyte-containing sheet of the embodiment of the invention suppresses the occurrence of short-circuit in an all-solid state secondary battery even after being stored and is capable of exhibiting a high battery voltage.

In addition, according to the manufacturing methods of the embodiment of the invention, it is possible to preferably manufacture a solid electrolyte-containing sheet and an all-solid state secondary battery respectively which have the above-described excellent performance.

The above-described and other characteristics and advantages of the present invention will be further clarified by the following description with appropriate reference to the accompanying drawings,

### BRIEF DESCRIPTION OF THE DRAWINGS

FIG. 1 is a vertical cross-sectional view schematically illustrating an all-solid state secondary battery according to a preferred embodiment of the present invention.

FIG. 2 is a vertical cross-sectional view schematically illustrating a device used in examples.

FIG. 3 is a vertical cross-sectional view schematically illustrating an all-solid state secondary battery (coin battery) produced in examples.

### DESCRIPTION OF THE PREFERRED EMBODIMENTS

### Preferred Embodiment

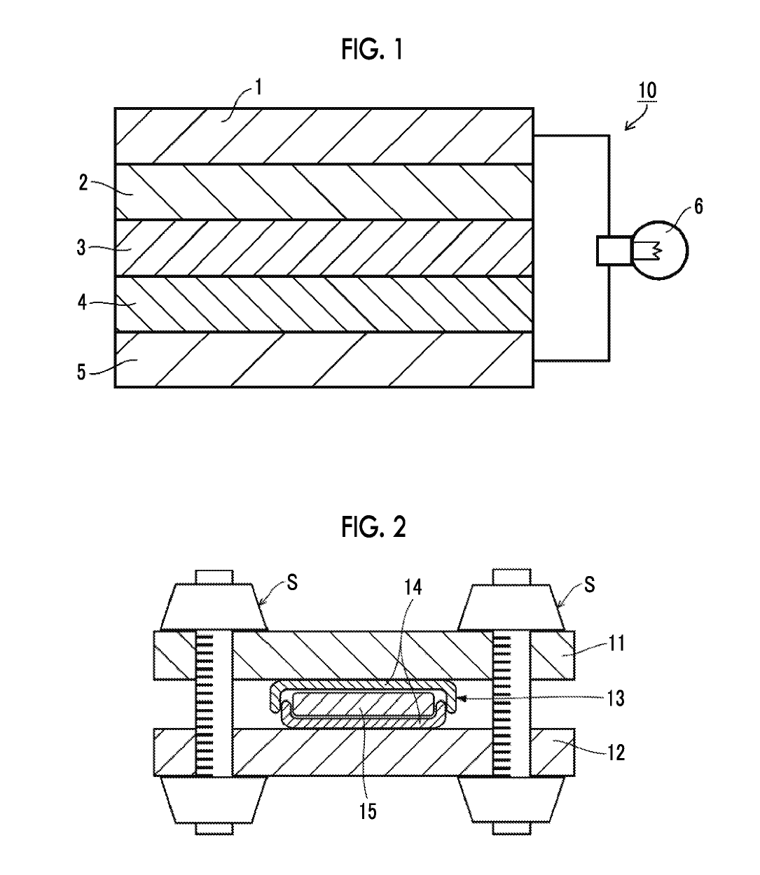

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging. A solid electrolyte composition of the embodiment of the invention can be preferably used as a material used to form the negative electrode active material layer, the positive electrode active material layer, and the solid electrolyte layer. In addition, a solid electrolyte-containing sheet of the embodiment of the invention is preferred as the negative electrode active material layer, the positive electrode active material layer, and the solid electrolyte layer.

In the present specification, the positive electrode active material layer (hereinafter, also referred to as the positive electrode layer) and the negative electrode active material layer (hereinafter, also referred to as the negative electrode layer) will be collectively referred to as the electrode layer or the active material layer in some cases.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm. In the all-solid state secondary battery of the embodiment of the invention, the thickness of at least one layer of the positive electrode active material layer 4, the solid electrolyte layer 3, or the negative electrode active material layer 2 is still more preferably 50 μm or more and less than 500 μm.

### Solid Electrolyte Composition

The solid electrolyte composition of the embodiment of the invention is a solid electrolyte composition containing (A) an inorganic solid electrolyte having the conductivity of an ion of a metal belonging to Group I or II of the periodic table, (B) a fluorine-containing compound satisfying all of the following conditions b1 to b4, and (C) a dispersion medium, in which the content of the fluorine-containing compound (B) in the total solid content of the solid electrolyte composition is 0.1% by mass or more and less than 20% by mass.

b1: as constituent atoms, a carbon atom and a fluorine atom are included, but a silicon atom is not included.

b2: N_{F}/N_{ALL} that is the ratio of the number N_{F} of fluorine atoms to the number N_{ALL} of all atoms satisfies 0.10≤N_{F}/N_{ALL}≤0.80.

b3: the molecular weight is less than 5,000, which does not apply to a polymer.

b4: the boiling point at a normal pressure or the Initiation temperature of thermal decomposition at a normal pressure exceeds 100° C.

Here, the components (A) to (C) are all the components of the solid electrolyte composition of the embodiment of the invention, and the component (A) is an inorganic solid electrolyte having the conductivity of an ion of a metal belonging to Group I or II of the periodic table, the component (B) is a fluorine-containing compound satisfying all of the conditions b1 to b4, and the component (C) is a dispersion medium.

Meanwhile, the solid electrolyte composition of the embodiment of the invention is not only an aspect in which the fluorine-containing compound (B) is dispersed in the solid electrolyte composition, but is also an aspect in which, for example, the fluorine-containing compound is eccentrically present on the surface.

### (A) Inorganic Solid Electrolyte

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (high-molecular-weight electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is a solid in a static state and is thus, generally, not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of ions of metals belonging to Group I or II of the periodic table and is generally a substance not having electron conductivity.

In the present invention, the inorganic solid electrolyte has conductivity of ions of metals belonging to Group I or II of the periodic table. As the inorganic solid electrolyte, it is possible to appropriately select and use solid electrolyte materials that are applied to this kind of products. Typical examples of the inorganic solid electrolyte include (i) sulfide-based inorganic solid electrolytes and (ii) oxide-based inorganic solid electrolytes. In the present invention, the sulfide-based inorganic solid electrolytes are preferably used since it is possible to form a more favorable interface between the active material and the inorganic solid electrolyte.

### (i) Sulfide-Based Inorganic Solid Electrolytes

Sulfide-based inorganic solid electrolytes are preferably inorganic solid electrolytes which contain sulfur atoms (S), have ion conductivity of metals belonging to Group I or II of the periodic table, and have electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (I).

Formula (I)

Lₐ₁M_{b1}P_{c1}S_{d1}Aₑ₁ (I)

In the formula, L represents an element selected from Li, Na, and K and is preferably Li. M represents an element selected from B, Zn, Sn, Si, Cu, Ga, Sb, Al, and Ge. A represents an element selected from 1, Br, C1, and F. a1 to e1 represent the compositional ratios among the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, Lil, LiBr, and LiCl), or sulfides of an element represented by M (for example, SiS₂, SnS, and GeS₂).

The ratio between Li₂S and P₂S₅ in Li—P—S-based glass and Li—P—S-based glass ceramic is preferably 60:40 to 90:10 and more preferably 68:32 to 78:22 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li₂S—P₂S₅, Li₂S—P₂S₅—LiCl, Li₂S—P₂S₅—H₂S, Li₂S—P₂S₅—H₂S—LiCl, Li₂S—Lil—P₂S₅, Li₂S—Lil—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SiS₂—LiCl, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂ and the like. Mixing ratios of the respective raw materials do not matter. Examples of a method for synthesizing sulfide-based inorganic solid electrolyte materials using the above-described raw material compositions include an amorphorization method. Examples of the amorphorization method include a mechanical milling method, a solution method, and a melting quenching method. This is because treatments at a normal temperature (25° C.) become possible, and it is possible to simplify manufacturing steps.

### (ii) Oxide-Based Inorganic Solid Electrolytes

Oxide-based inorganic solid electrolytes are preferably compounds which contain oxygen atoms (O), have an ion conductivity of metals belonging to Group I or II of the periodic table, and have electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In or Sn, xb satisfies 5≤xb≤10, yb satisfies 1≤yb≤4, zb satisfies 1≤zb≤4, mb satisfies 0≤mb≤2, and nb satisfies 5≤nb≤20.), Ti_{xc}B_{yc}M^{cc}_{zc}O_{nc} (M^{cc} is at least one element of C, S, Al, Si, Ga, Ge, In, or Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 1≤md≤7, 3≤nd≤13), Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms.), Li_{xf}Si_{yf}O_{zf} (1≤xf≤5, 0≤yf≤3, 1≤zf≤10), Li_{xg}S_{yg}O_{zg} (1≤xg≤3, 0<yg≤2, 1≤zg≤10), Li₃BO₃—Li₂SO₄, Li₂O—B₂O₃—P₂O₅, Li₂O—SiO₂, Li₆BaLa₂Ta₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure, Li_{1+xh+yh}(Al, Ga)ₓₕ(Ti, Ge)₂₋ₓₕSi_{yh}P_{3-yh}O₁₂ (0≤xh≤1, 0≤yh≤1), Ti₇La₃Zr₂O₁₂ (LLZ) having a garnet-type crystal structure. In addition, phosphorus compounds containing Li, P and O are also desirable. Examples thereof include lithium phosphate (Li₃PO₄), LiPON in which some of oxygen atoms in lithium phosphate are substituted with nitrogen, LiPOD¹ (D¹ is at least one element selected from Ti, V, Cr, Mn, Fe, Co, Ni, Cu, Zr, Nb, Mo, Ru, Ag, Ta, W, Pt, Au, or the like), and the like. It is also possible to preferably use LiA¹ON (A¹ represents at least one element selected from Si, B, Ge, Al, C, Ga, or the like) and the like.

The volume-average particle diameter of the inorganic solid electrolyte is not particularly limited, but is preferably 0.01 μm or more and more preferably 0.1 μm or more. The upper limit is preferably 100 μm or less and more preferably 50 μm or less. Meanwhile, the average particle diameter of the inorganic solid electrolyte particles is measured in the following order. One percent by mass of a dispersion liquid is obtained by dilution using the inorganic solid electrolyte particles and water (heptane in a case in which the inorganic solid electrolyte is unstable in water) in a 20 ml sample bottle. The diluted dispersion specimen is irradiated with 1 kHz ultrasonic waves tor 10 minutes and is then immediately used for testing. Data capturing is carried out 50 times using this dispersion liquid specimen, a laser ditYraction/scattering-type particle size distribution measurement instrument LA-920 (manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering method” is referred to as necessary. Five specimens are produced and measured per level, and the average values thereof are employed.

In a case in which a decrease in the interface resistance and the maintenance of the decreased interface resistance in the case of being used in the all-solid state secondary battery are taken into account, the content of the inorganic solid electrolyte in the solid component of the solid electrolyte composition is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

These inorganic solid electrolytes may be used singly or two or more inorganic solid electrolytes may be used in combination.

Meanwhile, the solid content (solid component) in the present specification refers to a component that does not volatilize or evaporate and thus disappear in the case of being subjected to a drying treatment in a nitrogen atmosphere at 80° C. for six hours. Typically, the solid content refers to a component other than a dispersion medium described below.

### (B) Fluorine-Containing Compound

The solid electrolyte composition of the embodiment of the invention contains (B) the fluorine-containing compound satisfying all of the following conditions b1 to b4.

b1: as constituent atoms, a carbon atom and a fluorine atom are included, but a silicon atom is not included.

b2: N_{F}/N_{ALL} that is the ratio of the number N_{F} of fluorine atoms to the number N_{ALL} of all atoms satisfies 0.10≤N_{F}/N_{ALL}≤0.80.

b3: the molecular weight is less than 5,000, which does not apply to a polymer.

b4: the boiling point at a normal pressure or the initiation temperature of thermal decomposition at a normal pressure exceeds 100° C.

In the condition b1, as the constituent atoms, in addition to a carbon atom and a fluorine atom, an atom selected from a hydrogen atom, an oxygen atom, a sulfur atom, and a nitrogen atom may be included. The constituent atom that may also be included is preferably an atom selected from a hydrogen atom, an oxygen atom, and a sulfur atom and more preferably an atom selected from a hydrogen atom and an oxygen atom.

In the condition b2, N_{F}/N_{ALL} preferably 0.20≤N_{F}/N_{ALL}≤0.60 and more preferably 0.30≤N_{F}/N_{ALL}≤0.50.

In the condition b3, “which does not apply to a polymer” means that the condition b3 does not apply to an irregular polymer or oligomer having a repeating unit and a regular polymer or oligomer.

The lower limit value of the molecular weight is preferably 100 or more, more preferably 200 or more, and still more preferably 500 or more. In addition, the upper limit value of the molecular weight is preferably less than 4,000 and more preferably less than 3,000.

In the condition b4, the lower limit value of the boiling point at a normal pressure is preferably 110° C. or higher, more preferably 140° C. or higher, and still more preferably 160° C. or higher. In addition, the upper limit value of the boiling point at a normal pressure is not particularly limited, but is realistically 500° C. or lower.

In the condition b4, the lower limit value of the initiation temperature of thermal decomposition at a normal pressure is preferably 250° C. or higher, more preferably 300° C. or higher, and still more preferably 400° C. or higher. In addition, the upper limit value of the initiation temperature of thermal decomposition at a normal pressure is not particularly limited, but is realistically 500° C. or lower.

Meanwhile, in the specification, in the case of being simply described, the boiling point refers to a boiling point at a normal pressure.

The fluorine-containing compound (B) is preferably solid at a normal temperature and a normal pressure (25° C. and 1,013 hPa), more preferably solid at 0° C. to 30° C. and a normal pressure (1,013 hPa), and still more preferably solid at 0° C. to 50° C. and a normal pressure (1,013 hPa) since it is possible to more effectively improve the water resistance of the solid electrolyte-containing sheet of the embodiment of the invention.

The fluorine-containing compound (B) preferably has an aromatic ring from the viewpoint of improving the surface eccentricity by the improvement of the planarity of the molecule. The aromatic ring is not particularly limited as long as the aromatic ring has aromaticity and may be any of an aromatic hetero ring or an aromatic hydrocarbon ring.

The aromatic hetero ring has a carbon atom and a hetero atom (a nitrogen atom, an oxygen atom, and/or a sulfur atom) as atoms that constitute the aromatic ring and may be condensed. The number of carbon atoms in the aromatic hetero ring is preferably 5 to 22, more preferably 5 to 20, and still more preferably 5 to 18, and the number of hetero atoms is preferably 1 to 4, more preferably 1 to 3, and still more preferably 1 or 2, and examples thereof include 1,3,5-triazine, pyrazine, imidazole, and quinoxalme.

In the aromatic hydrocarbon ring, the aromatic ring is constituted of carbon atoms and may be condensed. In the aromatic hydrocarbon ring, the number of carbon atoms is preferably 6 to 22, more preferably 6 to 20, and still more preferably 6 to 18, and examples thereof include benzene, naphthalene, anthracene, phenanthrene, phenalene, triphenylene, pyrene, chrysene, and naphthacene.

Among these, the aromatic hydrocarbon ring is preferred, and benzene or triphenylene is more preferred.

The fluorine-containing compound (B) is preferably at least one selected from compounds represented by any of Formulae (1) to (3).

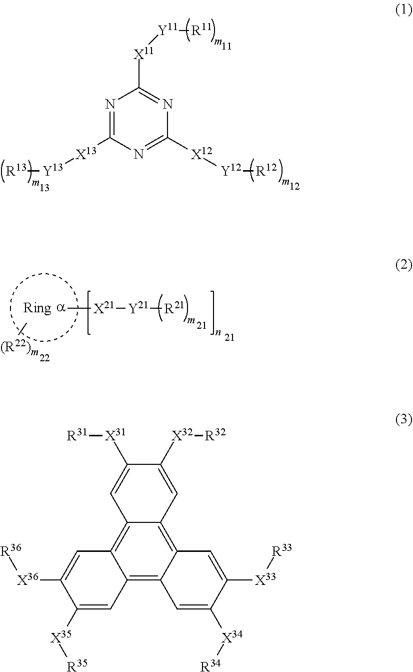

In Formula (1), R¹¹ to R¹³ each independently represent a fluorine-containing substituent or a hydrogen atom, X¹¹ to X¹³ each independently represent a single bond, an alkylene group, —O—, —S—, —C(═O)—, —NR—, or a divalent linking group formed of a combination thereof, Y¹¹ to Y¹³ each independently represent a single bond or an n-valent hydrocarbon group, and m₁₁ to m₁₃ each independently represent an integer of 1 to 5. Here, R represents a hydrogen atom or an alkyl group, and n is m₁₁+1, m₁₂+1, or m₁₃+1. In a case in which there is a plurality of R¹¹'s, the plurality of R¹¹'s may be identical to or different from each other, in a case in which there is a plurality of R¹²'s, the plurality of R¹²'s may be identical to or different from each other, and, in a case in which there is a plurality of R¹³'s, the plurality of R¹³'s may be identical to or different from each other. Here, at least one of R¹¹ to R¹³ represents a fluorine-containing substituent.

In Formula (2), a ring α represents a benzene ring or a naphthalene ring. R²¹ represents a fluorine-containing substituent or a hydrogen atom, X²¹ represents a single bond, an alkylene group, —O—, —S—, —C(═O)—, —NR—, or a divalent linking group formed of a combination thereof, Y²¹ represents a single bond or an m₂₁30 1-valent hydrocarbon group, m₂₁ represents an integer of 1 to 5, and n²¹ represents an integer of 1 to 8. Here, R represents a hydrogen atom or an alkyl group. R²² represents an organic group, and m₂₂ represents an integer of 0 to 7. In a case in which there is a plurality of R²¹'s, the plurality of R²¹'s may be identical to or different from each other, and, in a case in which there is a plurality of R²²'s, the plurality of R²²'s may be identical to or different from each other. Here, at least one of R²¹'s represents a fluorine-containing substituent.

In Formula (3), R³¹ to R³⁶ each independently represent a fluorine-containing substituent or a hydrogen atom, X³¹ to X³⁶ each independently represent a single bond, an alkylene group, —O—, —S—, —C(═O)—, —NR—, or a divalent linking group formed of a combination thereof. Here, R represents a hydrogen atom or an alkyl group. Here, at least one of R³¹ to R³⁶ represents a fluorine-containing substituent.

The fluorine-containing substituent as R¹¹ to R¹³, R²¹, and R³¹ to R³⁶ is preferably a fluorine atom, a fluorine-substituted alkyl group, a fluorine-substituted alkoxy group, a fluorine-substituted acyloxy group, a fluorine-substituted alkylamino group, a fluorine-substituted alkylsulfanyl group, or a fluorine-substituted acylamino group and more preferably a fluorine atom, a fluorine-substituted alkyl group, a fluorine-substituted alkoxy group, or a fluorine-substituted acyloxy group from the viewpoint of a high surface eccentricity and the solubility in the dispersion medium (C). Here, the fluorine-containing substituent has no silicon atom.

The fluorine-containing substituent as R¹¹ to R¹³, R²¹, and R³¹ to R³⁶ may have a bond such as an ester bond, an ether bond, or a thioether bond between carbon-carbon bonds.

The fluorine-containing substituent as R¹¹ to R¹³, R²¹, and R³¹ to R³⁶ preferably has a —CF₃ group or a —CF₂H group at a terminal, and the number of carbon atoms is preferably 4 to 20, more preferably 4 to 16, and still more preferably 6 to 16. The proportion of hydrogen atoms in the alkyl group and/or the aryl group in the fluorine-containing substituent which are substituted with a fluorine atom is preferably 40% or more, more preferably 50% or more, and still more preferably 60% or more. That is, in the fluorine-containing substituent, in a case in which the number of all hydrogen atoms in the alkyl group and/or the aryl group is set to 100%, the proportion of hydrogen atoms substituted with a fluorine atom is preferably 40% or more, more preferably 50% or more, and still more preferably 60% or more.

The fluorine-substituted alkyl group refers to an alkyl group in which part or all of hydrogen atoms included in the alkyl group are substituted with fluorine atoms. The fluorine-substituted alkyl group may have a linear shape or a branched shape and may have a C—Z—C structure (Z═hetero atom) between the carbon-carbon bonds through a hetero atom Z. This hetero atom Z is preferably an oxygen atom or a sulfur atom and more preferably an oxygen atom.

The fluorine-substituted alkyl group preferably has a —CF₃ group or a —CF₂H group at a terminal, and the number of carbon atoms is preferably 4 to 20, more preferably 4 to 16, and still more preferably 6 to 16. The proportion of hydrogen atoms in the alkyl group which are substituted with a fluorine atom is preferably 40% or more, more preferably 50% or more, and still more preferably 60% or more. That is, in the fluorine-substituted alkyl group, in a case in which the number of ail hydrogen atoms in the alkyl group is set to 100%, the proportion of hydrogen atoms substituted with a fluorine atom is preferably 40% or more, more preferably 50% or more, and still more preferably 60% or more.

Hereinafter, examples of the fluorine-substituted alkyl group will be described.

R1: n-C₈F₁₇—

R2: n-C₆F₁₃—

R3: n-C₄F₉—

R4: n-C₈F₁₇—(CH₂)₂—O—(CH₂)₂—

R5: n-C₆F₁₃—(CH₂)₂—O—(CH₂)₂—

R6: n-C₄F₉—(CH₂)₂—O—(CH₂)₂—

R7: n-C₈F₁₇—(CH₂)₃—

R8: n-C₆F₁₃—(CH₂)₃—

R9: n-C₄F₉—(CH₂)₃—

R10: H—(CF₂)₈—

R11: H—(CF₂)₆—

R12: H—(CF₂)₄—

R13: H—(CF₂)₈—(CH₂)—

R14: H—(CF₂)₆—(CH₂)—

R15: H—(CF₂)₄—(CH₂)—

R16: H—(CF₂)₈—(CH₂)—O—(CH₂)₂—

R17: H—(CF₂)₆—(CH₂)—O—(CH₂)₂—

R18: H—(CF₂)₄—(CH₂)—O—(CH₂)₂—

The fluorine-substituted alkoxy group refers to an alkoxy group in which part or all of hydrogen atoms included in the alkoxy group are substituted with fluorine atoms. The fluorine-substituted alkoxy group may have a linear shape or a branched shape and may have a C—Z—C structure (Z═hetero atom) between the carbon-carbon bonds through the hetero atom Z. This hetero atom Z is preferably an oxygen atom or a sulfur atom and more preferably an oxygen atom.

The fluorine-substituted alkoxy group preferably has a —CF₃ group or a —CF₂H group at a terminal, and the number of carbon atoms is preferably 4 to 20, more preferably 4 to 16, and still more preferably 6 to 16. The proportion of hydrogen atoms in the alkoxy group which are substituted with a fluorine atom is preferably 40% or more, more preferably 50% or more, and. still more preferably 60% or more. That is, in the fluorine-substituted alkoxy group, in a case in which the number of ail hydrogen atoms in the alkoxy group is set to 100%, the proportion of hydrogen atoms substituted with a fluorine atom is preferably 40% or more, more preferably 50% or more, and still more preferably 60% or more.

Hereinafter, examples of the fluorine-substituted alkoxy group will be described.

R1: n-C₈F₁₇—O—

R2: n-C₆F₁₃—O—

R3: n-C₄F₉—O—

R4: n-C₈F₁₇—(CH₂)₂—O—(CH₂)₂—O—

R5: n-C₆F₁₃—(CH₂)₂—O—(CH₂)₂—O—

R6: n-C₄F₉—(CH₂)₂—O—(CH₂)₂—O—

R7: n-C₈F₁₇—(CH₂)₃—O—

R8: n-C₆F₁₃—(CH₂)₃—O—

R9: n-C₄F₉—(CH₂)₃—O—

R10: H—(CF₂)₈—O—

R11: H—(CF₂)₆—O—

R12: H—(CF₂)₄—O—

R13: H—(CF₂)₈—(CH₂)—O—

R14: H—(CF₂)₆—(CH₂)—O—

R15: H—(CF₂)₄—(CH₂)—O—

R16: H—(CF₂)₈—(CH₂)—O—(CH₂)₂—O—

R17: H—(CF₂)₆—(CH₂)—O—(CH₂)₂—O—

R18: H—(CF₂)₄—(CH₂)—O—(CH₂)₂—O—

The fluorine-substituted acyloxy group refers to an acyloxy group in which part or all of hydrogen atoms included in the acyloxy group are substituted with fluorine atoms. Here, an aryloyloxy group is also considered as the acyloxy group in the fluorine-substituted acyloxy group. The fluorine-substituted acyloxy group may have a linear shape or a branched shape and may have an ester bond between the carbon-carbon bonds.

The fluorine-substituted acyloxy group preferably has a —CF₃ group or a —CF₂H group at a terminal, and the number of carbon atoms is preferably 4 to 20, more preferably 4 to 16, and still more preferably 6 to 16. The proportion of hydrogen atoms in the acyloxy group which are substituted with a fluorine atom is preferably 40% or more, more preferably 50% or more, and still more preferably 60% or more. That is, in the fluorine-substituted acyloxy group, in a case in which the number of all hydrogen atoms in the acyloxy group is set to 100%, the proportion of hydrogen atoms substituted with a fluorine atom is preferably 40% or more, more preferably 50%) or more, and still more preferably 60%) or more.

Hereinafter, examples of the fluorine-substituted acyloxy group will be described.

R1: n-C₈F₁₇—C(═O)O—

R2: n-C₈F₁₃—C(═O)O—

R3: n-C₄F₉—C(═O)O—

R4: n-C₈F₁₇—(CH₂)₂—OC(═O)—(CH₂)₂—C(═O)O—

R5: n-C₆F₁₃—(CH₂)₂—OC(═O)—(CH₂)₂—C(═O)O—

R6: n-C₄F₉—(CH₂)₂—OC(═O)—(CH₂)₂—C(═O)O—

R7: n-C₈F₁₇—(CH₂)₃—C(═O)O—

R8: n-C₆F₁₃—(CH₂)₃—C(═O)O—

R9: n-C₄F₉—(CH₂)₃—C(═O)O—

R10: H—(CF₂)₈—C(═O)O—

R11: H—(CF₂)₆—C(═O)O—

R12: H—(CF₂)₄—C(═O)O—

R13: H—(CF₂)₈—(CH₂)—C(═O)O—

R14: H—(CF₂)₆—(CH₂)—C(═O)O—

R15: H—(CF₂)₄—(CH₂)—C(═O)O—

R16: H—(CF₂)₈—(CH₂)—OC(═O)—(CH₂)₂—C(═O)—

R17: H—(CF₂)₆—(CH₂)—OC(═O)—(CH₂)₂—C(═O)—

R18: H—(CF₂)₄—(CH₂)—OC(═O)—(CH₂)₂—C(═O)—

The fluorine-substituted alkylamino group refers to an alkylamino group in which part or all of hydrogen atoms included in an alkyl group in the alkylamino group are substituted with fluorine atoms. The fluorine-substituted alkylamino group may have a linear shape or a branched shape and may have a C—Z—C structure (Z═hetero atom) between the carbon-carbon bonds through the hetero atom Z. This hetero atom Z is preferably an oxygen atom or a sulfur atom and more preferably an oxygen atom.

The fluorine-substituted alkylamino group preferably has a —CF₃ group or a —CF₂H group at a terminal, and the number of carbon atoms is preferably 4 to 20, more preferably 4 to 16, and still more preferably 6 to 16. The proportion of hydrogen atoms in the alkylamino group which are substituted with a fluorine atom is preferably 40% or more, more preferably 50% or more, and still more preferably 60% or more. That is, in the fluorine-substituted alkylamino group, in a case in which the number of all hydrogen atoms in an alkyl group of the alkylamino group is set to 100%, the proportion of hydrogen atoms substituted with a fluorine atom is preferably 40% or more, more preferably 50% or more, and still more preferably 60% or more.

Hereinafter, examples of the fluorine-substituted alkylamino group will be described.

R1: n-C₈F₁₇—NH—

R2: n-C₆F₁₃—NH—

R3: n-C₄F₉—NH—

R4: n-C₈F₁₇—(CH₂)₂—O—(CH₂)₂—NH—

R5: n-C₆F₁₃—(CH₂)₂—O—(CH₂)₂—NH—

R6: n-C₄F₉—(CH₂)₂—O—(CH₂)₂—NH—

R7: n-C₈F₁₇—(CH₂)₃—NH—

R8: n-C₆F₁₃—(CH₂)₃—NH—

R9: n-C₄F₉—(CH₂)₃—NH—

R10: H—(CF₂)₈—NH—

R11: H—(CF₂)₆—NH—

R12: H—(CF₂)₄—NH—

R13: H—(CF₂)₈—(CH₂)—NH—

R14: H—(CF₂)₆—(CH₂)—NH—

R15: H—(CF₂)₄—(CH₂)—NH—

R16: H—(CF₂)₈—(CH₂)—O—(CH₂)₂—NH—

R17: H—(CF₂)₆—(CH₂)—O—(CH₂)₂—NH—

R18: H—(CF₂)₄—(CH₂)—O—(CH₂)₂—NH—

The fluorine-substituted alkylsulfanyl group refers to an alkylsulfanyl group in which part or all of hydrogen atoms included in an alkyl group in the alkylsulfanyl group are substituted with fluorine atoms. The fluorine-substituted alkylsulfanyl group may have a linear shape or a branched shape and may have a C—Z—C structure (Z═hetero atom) between the carbon-carbon bonds through the hetero atom Z. This hetero atom Z is preferably an oxygen atom or a sulfur atom and more preferably an oxygen atom.

The fluorine-substituted alkylsulfanyl group preferably has a —CF₃ group or a —CF₂H group at a terminal, and the number of carbon atoms is preferably 4 to 20, more preferably 4 to 16, and still more preferably 6 to 16. The proportion of hydrogen atoms in the alkylsulfanyl group which are substituted with a fluorine atom is preferably 40% or more, more preferably 50% or more, and still more preferably 60% or more. That is, in the fluorine-substituted alkylsulfanyl group, in a case in which the number of all hydrogen atoms in the alkylsulfanyl group is set to 100%, the proportion of hydrogen atoms substituted with a fluorine atom is preferably 40% or more, more preferably 50% or more, and still more preferably 60% or more.

Hereinafter, examples of the fluorine-substituted alkylsulfanyl group will be described.

R1: n-C₈F₁₇—S—

R2: n-C₆F₁₃—S—

R3: n-C₄F₉—S—

R4: n-C₈F₁₇—(CH₂)₂—O—(CH₂)₂—S—

R5: n-C₆F₁₃—(CH₂)₂—O—(CH₂)₂—S—

R6: n-C₄F₉—(CH₂)₂—O—(CH₂)₂—S—

R7: n-C₈F₁₇—(CH₂)₃—S—

R8: n-C₆F₁₃—(CH₂)₃—S—

R9: n-C₄F₉—(CH₂)₃—S—

R10: H—(CF₂)₈—S—

R11: H—(CF₂)₆—S—

R12: H—(CF₂)₄—S—

R13: H—(CF₂)₈—(CH₂)—S—

R14: H—(CF₂)₆—(CH₂)—S—

R15: H—(CF₂)₄—(CH₂)—S—

R16: H—(CF₂)₈—(CH₂)—O—(CH₂)₂—S—

R17: H—(CF₂)₆—(CH₂)—O—(CH₂)₂—S—

R18: H—(CF₂)₄—(CH₂)—O—(CH₂)₂—S—

The fluorine-substituted acylamino group refers to an acylamino group in which part or ail of hydrogen atoms included in an alkyl group in the acylamino group are substituted with fluorine atoms. The fluorine-substituted acylamino group may have a linear shape or a branched shape and may have a C—Z—C structure (Z═hetero atom) between the carbon-carbon bonds through the hetero atom Z. This hetero atom Z is preferably an oxygen atom or a sulfur atom and more preferably an oxygen atom.

The fluorine-substituted acylamino group preferably has a —CF₃ group or a —CF₂H group at a terminal, and the number of carbon atoms is preferably 4 to 20, more preferably 4 to 16, and still more preferably 6 to 16. The proportion of hydrogen atoms in the acylamino group which are substituted with a fluorine atom is preferably 40% or more, more preferably 50% or more, and still more preferably 60% or more. That is, in the fluorine-substituted acylamino group, in a case in which the number of all hydrogen atoms in an alkyl group of the acylamino group is set to 100%, the proportion of hydrogen atoms substituted with a fluorine atom is preferably 40% or more, more preferably 50% or more, and still more preferably 60% or more.

Hereinafter, examples of the fluorine-substituted acylamino group will be described.

R1: n-C₈F₁₇—C(═O)NH—

R2: n-C₆F₁₃—C(═O)NH—

R3: n-C₄F₉—C(═O)NH—

R4: n-C₈F₁₇—(CH₂)₂—O—(CH₂)₂—C(═O)NH—

R5: n-C₆F₁₃—(CH₂)₂—O—(CH₂)₂—C(═O)NH—

R6: n-C₄F₉—(CH₂)₂—O—(CH₂)₂—C(═O)NH—

R7: n-C₈F₁₇—(CH₂)₃—C(═O)NH—

R8: n-C₆F₁₃—(CH₂)₃—C(═O)NH—

R9: n-C₄F₉—(CH₂)₃—C(═O)NH—

R10: H—(CF₂)₈—C(═O)NH—

R11: H—(CF₂)₆—C(═O)NH—

R12: H—(CF₂)₄—C(═O)NH—

R13: H—(CF₂)₈—(CH₂)—C(═O)NH—

R14: H—(CF₂)₆—(CH₂)—C(═O)NH—

R15: H—(CF₂)₄—(CH₂)—C(═O)NH—

R16: H—(CF₂)₈—(CH₂)—O—(CH₂)₂—C(═O)NH—

R17: H—(CF₂)₆—(CH₂)—O—(CH₂)₂—C(═O)NH—

R18: H—(CF₂)₄—(CH₂)—O—(CH₂)₂—C(═O)NH—

R¹¹ to R¹³ are preferably the fluorine-containing substituent, more preferably the fluorine-substituted alkyl group, the fluorine-substituted alkoxy group, the fluorine-substituted acyloxy group, the fluorine-substituted alkylsulfanyl group, or the fluorine-substituted acylamino group, and still more preferably the fluorine-substituted alkoxy group.

R²¹ is preferably the fluorine-containing substituent, more preferably a fluorine atom, the fluorine-substituted alkyl group, the fluorine-substituted alkoxy group, the fluorine-substituted acyloxy group, the fluorine-substituted alkylamino group, or the fluorine-substituted alkylsulfanyl group, and still more preferably a fluorine atom, the fluorine-substituted alkoxy group, or the fluorine-substituted acyloxy group.

R³¹ to R³⁶ are preferably the fluorine-containing substituent and more preferably the fluorine-substituted alkyl group or the fluorine-substituted alkoxy group.

As the organic group as R²², an alkyl group (the number of carbon atoms is preferably 1 to 12 and more preferably 1 to 6, for example, methyl and ethyl are exemplified, and methyl is preferred) and an acidic group.

The acidic group is preferably a carboxy group, a phosphate group, or a sulfonic acid group and more preferably a carboxy group.

R²² is preferably a methyl group or a carboxy group.

In —NR— as X¹¹ to X¹³, X²¹, and X³¹ to X³⁶, R represents a hydrogen atom or an alkyl group. As the alkyl group as R, alkyl groups described in the section of a substituent P described below can be exemplified.

Among these, R is preferably a hydrogen atom.

As the divalent linking group formed of a combination of an alkylene group (the number of carbon atoms is preferably 1 to 12 and more preferably 1 to 6, methylene, ethylene, or the like), —0—, —S—, —C(═O)—, —NR— as X¹¹ to X¹³, X²¹, and X³¹ to X³⁶, —C(═O)O—, —C(═O)NR—, —O-alkylene-, —S-alkylene-, —O-alkylene-O—, —O-alkylene-S—, —S-alkylene-S—, —O-alkylene-NR—, —S-alkylene-NR—, and —OC(═O)-alkylene-C(═O)O— are exemplified, —C(═O)O—, —C(═O)NR—, —O-alkylene-, —O-alkylene-O—, —O-alkylene-S—, —O-alkylene-NR—, or —OC(═O)-alkylene-C(═O)O—is preferred, —C(═O)O—or —C(═O)NR—is more preferred, and C(═O)O—or —C(═O)NH—is still more preferred. Meanwhile, the divalent linking group may be bonded on any side.

X¹¹ to X¹³ are preferably —O—, —S—, —NR—, —O-alkylene-O—, —O-alkylene-S—, or —O-alkylene-NR—, more preferably —NR—, and still more preferably —NH—.

X²¹ is preferably a single bond, —O—, —S—, —NR—, —C—(═O)O—, —O-alkylene-O—, —O-alkylene-S—, or —OC(═O)-alkylene-C(═O)O— and more preferably a single bond or —C(═O)O—.

X³¹ to X³⁶ are preferably a single bond, —O-alkylene-, —O-alkylene-O—, or —O-alkylene-S—and more preferably a single bond.

As the n-valent hydrocarbon group as Y¹¹ to Y¹³ and the m₂₁+1-valent hydrocarbon group as Y²¹, di- to hexavalent hydrocarbon groups are exemplified.

Preferred examples of the di- to hexavalent hydrocarbon groups include a divalent hydrocarbon group such as an alkylene group (preferably having 1 to 12 carbon atoms and more preferably 1 to 6 carbon atoms, methylene, ethylene, or the like) and an arylene group (preferably having 6 to 20 carbon atoms and more preferably having 6 to 14 carbon atoms, phenylene, naphthalenediyl, or the like), trivalent hydrocarbon groups such as an alkanetriyl group (preferably having 1 to 12 carbon atoms and more preferably having 1 to 6 carbon atoms, methanetriyl, ethanetriyl, or the like) and an arenetriyl group (preferably having 6 to 20 carbon atoms and more preferably having 6 to 14 carbon atoms, benzenetriyl, naphthalenetriyl, or the like), and tetravalent hydrocarbon groups such as an alkanetetrayl group (preferably having 1 to 12 carbon atoms and more preferably having 1 to 6 carbon atoms, methanetetrayl, ethanetetrayl, or the like) and areantetrayl group (preferably having 6 to 20 carbon atoms and more preferably 6 to 14 carbon atoms, benzene tetrayl, naphthalene tetrayl, or the like).

Among these, the di- to tetra-valent hydrocarbon groups are preferred, and an arylene group, an arenetriyl group, or an arenetetrayl group are more preferred.

Y¹¹ to Y¹³ are preferably a di- to hexavalent hydrocarbon group, more preferably a di- to tetravalent hydrocarbon group, still more preferably an arylene group, an arenetriyl group, or an arenetetrayl group, and particularly preferably a benzene triyl group.

In a case in which the ring α is a benzene ring, Y²¹ is preferably a di- to hexavalent hydrocarbon group, more preferably a di- to tetravalent hydrocarbon group, still more preferably an arylene group, an arene-triyl group, or an arene-tetrayl group, and particularly preferably a phenylene group, a benzene triyl group, or a benzene tetrayl group. In a case in which the ring α is a naphthalene ring, Y²¹ is preferably a single bond.

m₁₁ to m₁₃ are preferably an integer of 1 to 4, more preferably an integer of 1 to 3, and still more preferably 1 or 2.

In a case in which, the ring α is a benzene ring, m₂₁ is preferably an integer of 1 to 4 and more preferably an integer of 1 to 3, and, in a case in which the ring α is a naphthalene ring, n²¹ is preferably an integer of 1 to 4 and more preferably an integer of 1 to 3, and still more preferably 1 or 2.

In a case in which the ring α is a benzene ring, n²¹ is preferably an integer of 1 to 4 and more preferably an integer of 1 to 3, and, in a case in which the ring α is a naphthalene ring, n²¹ is preferably an integer of 1 to 4 and more preferably an integer of 1 to 3, and still more preferably 1 or 2.

In a case in which the ring α is a benzene ring, m₂₂ is preferably an integer of 1 to 3 and more preferably 1 or 2, and, in a case in which the ring α is a naphthalene ring, m₂₂ is preferably an integer of 0 to 2 and more preferably 0 or 1.

The compound represented by Formula (1) is preferably represented by Formula (1a) or (1b).

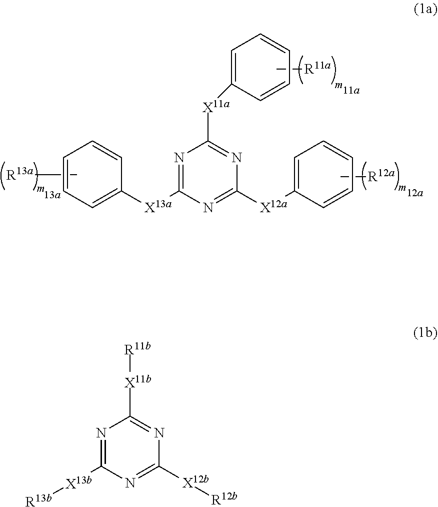

In Formulae (1a) and (1b), R^{11a} to R^{13a}, R^{11b} to R^{13b}, X^{11a} to X^{13a}, X^{11b} to X^{13b}, and m₁₁ₐ to m₁₃ₐ are the same as R¹¹ to R¹³, X¹¹ to X¹³, and m₁₁ to m₁₃ in Formula (1).

The compound represented by Formula (2) is preferably represented by Formula (2a) or (2b).

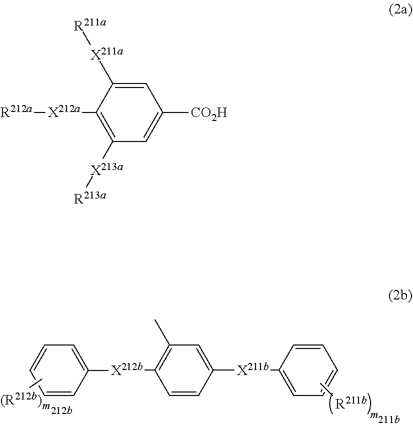

In Formulae (2a) and (2b), R^{211a} to R^{213a}, R^{211b} and R^{212b}, X^{211a} to X^{213a}, X^{211b} to X^{212b}, and m₂₁₁ₐ to m_{212b} are the same as R²¹, X²¹, and m₂₁ in a case in which the ring α is a benzene ring.

The compound represented by Formula (2) is preferably represented by Formula (2c).

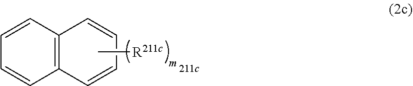

In Formula (2c), R^{211c} and m_{211c} are the same as R²¹ in Formula (2) and m₂₁ in a case in which the ring α is a naphthalene ring.

The compound represented by Formula (3) is preferably represented by Formula (3a).

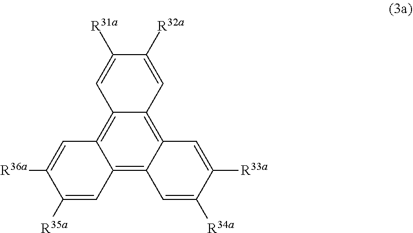

In Formula (3a), R^{33a} to R^{36a} are the same as R³³ to R³⁶ in Formula (3).

The fluorine-containing compound (B) of the present invention can be purchased from Tokyo Chemical Industry Co., Ltd., Wako Pure Chemical Industries, Ltd., Aldrich-Sigma, Co. LLC., and the like. In addition, the fluorine-containing compound (B) of the present invention can be synthesized by a nucleophilic substitution reaction into a halogen, a Williamson ether synthesis, a condensation reaction between carboxylic acid and phenyl, or the like using a raw material purchased from Tokyo Chemical Industry Co., Ltd., Wako Pure Chemical Industries, Ltd., Aldrich-Sigma, Co. LLC., and the like.

Hereinafter, the fluorine-containing compound (B) that is used in the present invention will be illustrated, but the present invention is not limited thereto.

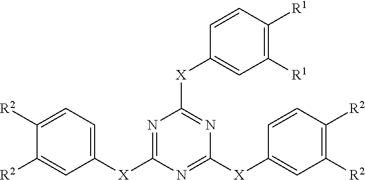

| No. | R¹ | R² | X |
|---|---|---|---|
| B-1 | —O(CH₂)₃(CF₂)₄F | —O(CH₂)₃(CF₂)₄F | —NH— |
| B-2 | —O(CH₂)₃(CF₂)₆F | —O(CH₂)₃(CF₂)₆F | —NH— |
| B-3 | —O(CH₂)₃(CF₂)₈F | —O(CH₂)₃(CF₂)₈F | —NH— |
| B-4 | —OCH₂(CF₂)₆H | —OCH₂(CF₂)₆H | —NH— |
| B-5 | —OCH₂(CF₂)₈H | —OCH₂(CF₂)₈H | —NH— |
| B-6 | —O(CH₂)₂O(CH₂)₂(CF₂)₆F | —O(CH₂)₂O(CH₂)₂(CF₂)₆F | —NH— |
| B-7 | —O(CH₂)₂O(CH₂)₂(CF₂)₄F | —O(CH₂)₂O(CH₂)₂(CF₂)₄F | —NH— |
| B-8 | —O(CH₂)₃S(CH₂)₂(CF₂)₆F | —O(CH₂)₃S(CH₂)₂(CF₂)₆F | —NH— |
| B-9 | —O(CH₂)₃S(CH₂)₂(CF₂)₄F | —O(CH₂)₃S(CH₂)₂(CF₂)₄F | —NH— |
| B-10 | —O(CH₂)₆S(CH₂)₂(CF₂)₆F | —O(CH₂)₆S(CH₂)₂(CF₂)₆F | —NH— |
| B-11 | —O(CH₂)₆S(CH₂)₂(CF₂)₄F | —O(CH₂)₆S(CH₂)₂(CF₂)₄F | —NH— |
| B-12 | —OC(═O)(CF₂)₄F | —OC(═O)(CF₂)₄F | —NH— |
| B-13 | —OC(═O)(CF₂)₈F | —OC(═O)(CF₂)₈F | —NH— |
| B-14 | —OC(═O)(CF₂)₁₀F | —OC(═O)(CF₂)₁₀F | —NH— |
| B-15 | —NHC(═O)(CF₂)₁₀F | —NHC(═O)(CF₂)₁₀F | —NH— |
| B-16 | —S(CH₂)₅(CF₂)₄F | —S(CH₂)₅(CF₂)₄F | —NH— |
| B-17 | —O(CH₂)₂O(CH₂)(CF₂)₆H | —O(CH₂)₂O(CH₂)(CF₂)₆H | —NH— |
| B-18 | —O(CH₂)₃(CF₂)₆F | —O(CH₂)₃(CF₂)₆F | —O— |
| B-19 | —OCH₂(CF₂)₆H | —OCH₂(CF₂)₆H | —O— |
| B-20 | —O(CH₂)₂O(CH₂)₂(CF₂)₆F | —O(CH₂)₂O(CH₂)₂(CF₂)₆F | —O— |
| B-21 | —O(CH₂)₃S(CH₂)₂(CF₂)₆F | —O(CH₂)₃S(CH₂)₂(CF₂)₆F | —O— |
| B-22 | —O(CH₂)₂O(CH₂)(CF₂)₆H | —O(CH₂)₂O(CH₂)(CF₂)₆H | —O— |
| B-23 | —O(CH₂)₃(CF₂)₆F | —O(CH₂)₃(CF₂)₆F | —S— |
| B-24 | —OCH₂(CF₂)₆H | —OCH₂(CF₂)₆H | —S— |
| B-25 | —O(CH₂)₂O(CH₂)₂(CF₂)₆F | —O(CH₂)₂O(CH₂)₂(CF₂)₆F | —S— |
| B-26 | —O(CH₂)₃S(CH₂)₂(CF₂)₆F | —O(CH₂)₃S(CH₂)₂(CF₂)₆F | —S— |
| B-27 | —O(CH₂)₂O(CH₂)(CF₂)₆H | —O(CH₂)₂O(CH₂)(CF₂)₆H | —S— |

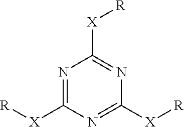

| No. | R | X |
|---|---|---|
| B-28 | —(CH₂)₂(CF₂)₄F | —O— |
| B-29 | —(CH₂)₂(CF₂)₆F | —O— |
| B-30 | —(CH₂)₂(CF₂)₈F | —O— |
| B-31 | —CH₂(CF₂)₆H | —O— |
| B-32 | —CH₂(CF₂)₈H | —O— |
| B-33 | —(CH₂)₂(CF₂)₆F | —O(CH₂)₂O— |
| B-34 | —(CH₂)₂(CF₂)₄F | —O(CH₂)₂O— |
| B-35 | —(CH₂)₂(CF₂)₆F | —O(CH₂)₂S— |
| B-36 | —(CH₂)₂(CF₂)₈F | —O(CH₂)₂S— |
| B-37 | —CH₂(CF₂)₈F | —NH(CH₂)₂O— |
| B-38 | —CH₂(CF₂)₆H | —NH(CH₂)₂O— |
| B-39 | —CH₂(CF₂)₈H | —NH(CH₂)₂O— |

X in the cable links with a triazine ring on the left and links with it on the right side.

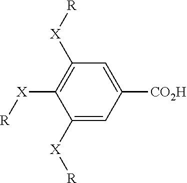

| No. | R | X |
|---|---|---|
| B-40 | —(CH₂)₂(CF₂)₄F | —O— |
| B-41 | —(CH₂)₂(CF₂)₆F | —O— |
| B-42 | —(CH₂)₂(CF₂)₈F | —O— |
| B-43 | —CH₂(CF₂)₆H | —O— |
| B-44 | —CH₂(CF₂)₈H | —O— |
| B-45 | —CH₂(CF₂)₆F | —O(CH₂)₂O— |
| B-46 | —CH₂(CF₂)₄F | —O(CH₂)₂O— |
| B-47 | —CH₂(CF₂)₆F | —O(CH₂)₂S— |
| B-48 | —CH₂(CF₂)₈F | —O(CH₂)₂S— |
| B-49 | —(CH₂)₂(CF₂)₆F | —OC(═O)(CH₂)₂C(═O)O— |

X in the table links with a benzene ring on the left side and links with R on the right side.

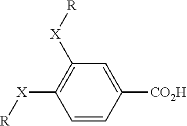

| No. | R | X |
|---|---|---|
| B-50 | —(CH₂)₂(CF₂)₄F | —O— |
| B-51 | —(CH₂)₂(CF₂)₆F | —O— |
| B-52 | —(CH₂)₂(CF₂)₈F | —O— |
| B-53 | —CH₂(CF₂)₆H | —O— |
| B-54 | —CH₂(CF₂)₈H | —O— |
| B-55 | —CH₂(CF₂)₆F | —O(CH₂)₂O— |
| B-56 | —CH₂(CF₂)₄F | —O(CH₂)₂O— |
| B-57 | —CH₂(CF₂)₆F | —O(CH₂)₂S— |
| B-58 | —CH₂(CF₂)₈F | —O(CH₂)₂S— |

X in the table links with a benzene ring on the left side and links with R on the right side.

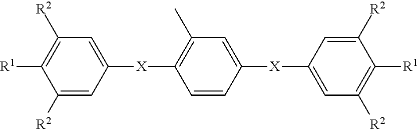

| No. | R¹ | R² | X |
|---|---|---|---|
| B-59 | —O(C═O)(CH₂)₂C(═O)O(CH₂)₂(CF₂)₆F | — | —(C═O)O— |
| B-60 | —O(C═O)(CH₂)₂C(═O)O(CH₂)₂(CF₂)₈F | — | —(C═O)O— |
| B-61 | —O(C═O)(CH₂)₂C(═O)O(CH₂)₂(CF₂)₆F | — | —(C═O)O— |
| B-62 | —O(C═O)(CH₂)₂C(═O)O(CH₂)₂(CF₂)₈F | — | —(C═O)O— |
| B-63 | —O(CH₂)₂O(CH₂)₂(CF₂)₆F | — | —(C═O)O— |
| B-64 | —O(CH₂)₂(CF₂)₈F | — | —O— |
| B-65 | —NH(CH₂)₂(CF₂)₆F | — | —NH— |
| B-66 | —NH(CH₂)₂(CF₂)₈F | — | —NH— |
| B-67 | —S(CH₂)₂(CF₂)₆F | — | —S— |
| B-68 | —S(CH₂)₂(CF₂)₈F | — | —S— |
| B-69 | —O(C═O)(CH₂)₂C(═O)O(CH₂)₂(CF₂)₆F | —O(C═O)(CH₂)₂C(═O)O(CH₂)₂(CF₂)₆F | —(C═O)O— |
| B-70 | —O(C═O)(CH₂)₂C(═O)O(CH₂)₂(CF₂)₈F | —O(C═O)(CH₂)₂C(═O)O(CH₂)₂(CF₂)₈F | —(C═O)O— |
| B-71 | —O(CH₂)₂O(CH₂)₂(CF₂)₆F | —O(CH₂)₂O(CH₂)₂(CF₂)₆F | —(C═O)O— |
| B-72 | —O(CH₂)₂O(CH₂)₂(CF₂)₈F | —O(CH₂)₂O(CH₂)₂(CF₂)₈F | —(C═O)O— |
| B-73 | —O(CH₂)₂(CF₂)₆F | —O(CH₂)₂(CF₂)₆F | —(C═O)O— |
| B-74 | —O(CH₂)₂(CF₂)₈F | —O(CH₂)₂(CF₂)₈F | —(C═O)O— |
| B-75 | —NH(CH₂)₂(CF₂)₆F | —NH(CH₂)₂(CF₂)₆F | —(C═O)O— |
| B-76 | —S(CH₂)₂(CF₂)₆F | —S(CH₂)₂(CF₂)₆F | —(C═O)O— |

X in the table links with a benzene ring in the center on the left side and links with both side benzene rings on the right side.

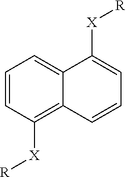

| No. | R | X |
|---|---|---|
| B-77 | —(CH₂)₂(CF₂)₆F | —O(C═O)(CH₂)₂C(═O)O— |
| B-78 | —(CH₂)₂(CF₂)₈F | —O(C═O)(CH₂)₂C(═O)O— |
| B-79 | —(CH₂)₂(CF₂)₆F | —O(C═O)(CH₂)₂C(═O)O— |
| B-80 | —(CH₂)₂(CF₂)₈F | —O(C═O)(CH₂)₂C(═O)O— |
| B-81 | —(CH₂)₂O(CH₂)₂(CF₂)₆F | —O— |
| B-82 | —(CH₂)₂(CF₂)₈F | —O— |
| B-83 | —(CH₂)₂(CF₂)₆F | —NH— |
| B-84 | —(CH₂)₂(CF₂)₈F | —NH— |
| B-85 | —(CH₂)₂(CF₂)₆F | —S— |
| B-86 | —(CH₂)₂(CF₂)₈F | —S— |
| B-87 | —(CH₂)₂(CF₂)₆F | —O(C═O)(CH₂)₂C(═O)O— |
| B-88 | —(CH₂)₂(CF₂)₈F | —O(C═O)(CH₂)₂C(═O)O— |
| B-89 | —(CH₂)₂O(CH₂)₂(CF₂)₆F | —O— |
| B-90 | —(CH₂)₂O(CH₂)₂(CF₂)₈F | —O— |
| B-91 | —(CH₂)₂(CF₂)₆F | —O— |
| B-92 | —(CH₂)₂(CF₂)₈F | —O— |
| B-93 | —(CH₂)₂(CF₂)₆F | —NH— |
| B-94 | —(CH₂)₂(CF₂)₆F | —S— |

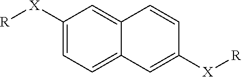

| No. | R | X |
|---|---|---|
| B-95 | —(CH₂)₂(CF₂)₆F | —O(C═O)(CH₂)₂C(═O)O— |
| B-96 | —(CH₂)₂(CF₂)₈F | —O(C═O)(CH₂)₂C(═O)O— |
| B-97 | —(CH₂)₂(CF₂)₆F | —O(C═O)(CH₂)₂C(═O)O— |
| B-98 | —(CH₂)₂(CF₂)₈F | —O(C═O)(CH₂)₂C(═O)O— |
| B-99 | —(CH₂)₂O(CH₂)₂(CF₂)₆F | —O— |
| B-100 | —(CH₂)₂(CF₂)₈F | —O— |
| B-101 | —(CH₂)₂(CF₂)₆F | —NH— |
| B-102 | —(CH₂)₂(CF₂)₈F | —NH— |
| B-103 | —(CH₂)₂(CF₂)₆F | —S— |
| B-104 | —(CH₂)₂(CF₂)₈F | —S— |
| B-105 | —(CH₂)₂(CF₂)₆F | —O(C═O)(CH₂)₂C(═O)O— |
| B-106 | —(CH₂)₂(CF₂)₈F | —O(C═O)(CH₂)₂C(═O)O— |
| B-107 | —(CH₂)₂O(CH₂)₂(CF₂)₆F | —O— |
| B-108 | —(CH₂)₂O(CH₂)₂(CF₂)₈F | —O— |
| B-109 | —(CH₂)₂(CF₂)₆F | —O— |
| B-110 | —(CH₂)₂(CF₂)₈F | —O— |
| B-111 | —(CH₂)₂(CF₂)₆F | —NH— |
| B-112 | —(CH₂)₂(CF₂)₆F | —S— |

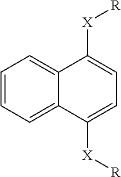

| No. | R | X |
|---|---|---|
| B-113 | —(CH₂)₂(CF₂)₆F | —O(C═O)(CH₂)₂C(═O)O— |
| B-114 | —(CH₂)₂(CF₂)₈F | —O(C═O)(CH₂)₂C(═O)O— |
| B-115 | —(CH₂)₂(CF₂)₆F | —O(C═O)(CH₂)₂C(═O)O— |
| B-116 | —(CH₂)₂(CF₂)₈F | —O(C═O)(CH₂)₂C(═O)O— |
| B-117 | —(CH₂)₂O(CH₂)₂(CF₂)₆F | —O— |
| B-118 | —(CH₂)₂(CF₂)₈F | —O— |
| B-119 | —(CH₂)₂(CF₂)₆F | —NH— |
| B-120 | —(CH₂)₂(CF₂)₈F | —NH— |
| B-121 | —(CH₂)₂(CF₂)₆F | —S— |
| B-122 | —(CH₂)₂(CF₂)₈F | —S— |
| B-123 | —(CH₂)₂(CF₂)₆F | —O(C═O)(CH₂)₂C(═O)O— |
| B-124 | —(CH₂)₂(CF₂)₈F | —O(C═O)(CH₂)₂C(═O)O— |
| B-125 | —(CH₂)₂O(CH₂)₂(CF₂)₆F | —O— |
| B-126 | —(CH₂)₂O(CH₂)₂(CF₂)₈F | —O— |
| B-127 | —(CH₂)₂(CF₂)₆F | —O— |
| B-128 | —(CH₂)₂(CF₂)₈F | —O— |
| B-129 | —(CH₂)₂(CF₂)₆F | —NH— |
| B-130 | —(CH₂)₂(CF₂)₈F | —S— |

| 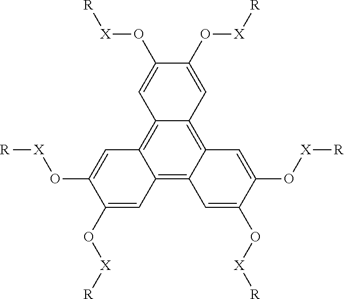 | | |
|---|---|---|
| No. | R | X |
| B-131 | —(CF₂)₄F | —(CH₂)₃— |
| B-132 | —(CF₂)₆F | —(CH₂)₃— |
| B-133 | —(CF₂)₈F | —(CH₂)₃— |
| B-134 | —(CF₂)₆H | —CH₂— |
| B-135 | —(CF₂)₈H | —CH₂— |
| B-136 | —(CH₂)₂(CF₂)₆F | —(CH₂)₂O— |
| B-137 | —(CH₂)₂(CF₂)₄F | —(CH₂)₂O— |
| B-138 | —(CH₂)₂(CF₂)₆F | —(CH₂)₂S— |
| B-139 | —(CH₂)₂(CF₂)₈F | —(CH₂)₂S— |

X in the table Sinks with an oxygen atom on the left side and links with R on the right side.

The content of the fluorine-containing compound (B) in the total solid content of the solid electrolyte composition of the embodiment of the invention is 0.1% by mass or more and less than 20% by mass, preferably 1 to 10% by mass, and more preferably 2 to 5% by mass from the viewpoint of the water resistance and the battery performance.

In addition, the content of the fluorine-containing compound (B) is preferably more than 0 parts by mass to less than 500 parts by mass, more preferably 0.1 to less than 500 parts by mass, still more preferably 5 to 200 parts by mass, and particularly preferably 10 to 50 parts by mass with respect to 100 parts by mass of the inorganic solid electrolyte.

In the present specification, compounds, partial structures, or groups that are not clearly expressed as substituted or unsubstituted may have an appropriate substituent in the compounds, partial structures, or groups. What has been described above shall also apply to compounds that are not clearly expressed as substituted or unsubstituted. Preferred examples of the substituent include the substituent P described below.

Examples of the substituent P include the following substituents:

an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, 1-carboxymethyl, or the like), an alkenyl group (preferably an alkenyl group having 2 to 20 carbon atoms, for example, vinyl, allyl, oleyl, or the like), an alkynyl group (preferably an alkynyl group having 2 to 20 carbon atoms, for example, ethynyl, butadiynyl, phenylethynyl, or the like), a cycloalkyl group (preferably a cycloalkyl group having 3 to 20 carbon atoms, for example, cyclopropyl, cyclopentyl, cyclohexyl, 4-methylcyclohexyl, or the like; here, in the case of being referred to as an alkyl group in the present specification, generally, a cycloalkyl group is also referred to), an aryl group (preferably an aryl group having 6 to 26 carbon atoms, for example, phenyl, 1-naphthyl, 4-methoxyphenyl, 2-chlorophenyl, 3-methylphenyl, or the like), an aralkyl group (preferably an aralkyl group having 7 to 23 carbon atoms, for example, benzyl, phenethyl, or the like), a heterocyclic group (preferably a heterocyclic group having 2 to 20 carbon atoms, preferably a 5- or 6-membered heterocyclic group having at least one selected from an oxygen atom, a sulfur atom, or a nitrogen atom as a ring-constituting atom, for example, tetrahydropyranyl, tetrahydrofuranyl, 2-pyridyl, 4-pyridyl, 2-imidazolyl, 2-benzimidazolyl, 2-thiazolyl, 2-oxazolyl, pyrrolidone group, or the like), an alkoxy group (preferably an alkoxy group having 1 to 20 carbon atoms, for example, methoxy, ethoxy, isopropyloxy, benzyloxy, or the like), an aryloxy group (preferably an aryloxy group having 6 to 26 carbon atoms, for example, phenoxy, 1-naphthyloxy, 3-methylphenoxy, 4-methoxyphenoxy, or the like; here, in the case of being referred to as an alkoxy group in the present specification, generally, an aryloyl group is also referred to), an alkoxycarbonyl group (preferably an alkoxycarbonyl group having 2 to 20 carbon atoms, for example, ethoxycarbonyl, 2-ethylhexyloxycarbonyl, or the like), an aryloxycarbonyl group (preferably an aryloxycarbonyl group having 6 to 26 carbon atoms, for example, phenoxycarbonyl, 1-naphthyloxycarbonyl, 3-methylphenoxycarbonyl, 4-methoxyphenoxycarbonyl, or the like), an amino group (preferably an amino group, alkylamino group, or arylamino group having 0 to 20 carbon atoms, for example, amino, N,N-dimethylamino, N,N-diethylamino, N-ethylamino, anilino, or the like), a sulfamoyl group (preferably a sulfamoyl group having 0 to 20 carbon atoms, for example, N,N-dimethylsulfamoyl, N-phenylsulfamoyl, or the like), an acyl group (preferably an acyl group having 1 to 20 carbon atoms, for example, acetyl, propionyl, butyryl, or the like), an aryloyl group (preferably an aryloyl group having 7 to 23 carbon atoms, for example, benzoyl or the like; here, in the case of being referred to as an acyl group in the present specification, generally, an aryloyl group is also referred to), an acyloxy group (preferably an acyloxy group having 1 to 20 carbon atoms, for example, acetyloxy, or the like), an aryloyloxy group (preferably an aryloyloxy group having 7 to 23 carbon atoms, for example, benzoyloxy, or the like; here, in the case of being referred to as an acyloxy group in the present specification, generally, an aryloyloxy group is also referred to), a carbamoyl group (preferably a carbamoyl group having 1 to 20 carbon atoms, for example, N,N-dimethylcarbamoyl, N-phenylcarbamoyl, or the like), an acylamino group (preferably an acylamino group having 1 to 20 carbon atoms, for example, acetylamino, benzoylamino, or the like), an alkylsulfanyl group (preferably an alkylsulfanyl group having 1 to 20 carbon atoms, for example, methylsulfanyl, ethylsulfanyl, isopropylsulfanyl, benzylsulfanyl, or the like), an arylsulfanyl group (preferably an arylsulfanyl group having 6 to 26 carbon atoms, for example, phenylsulfanyl, 1-naphthylsulfanyl, 3-methylphenylsulfanyl, 4-methoxyphenylsulfanyl, or the like), an alkylsulfonyl group (preferably an alkylsulfonyl group having 1 to 20 carbon atoms, for example, methylsulfonyl, ethylsulfonyl, or the like), an arylsulfonyl group (preferably an arylsulfonyl group having 6 to 22 carbon atoms, for example, benzenesulfonyl or the like), a phosphoyl group (preferably a phosphoryl group having 0 to 20 carbon atoms, for example, —OP(═O)(R^{P})₂), a phosphonyl group (preferably a phosphonyl group having 0 to 20 carbon atoms, for example, —P(═O)(R^{P})₂), a phosphinyl group (preferably a phosphinyl group having 0 to 20 carbon atoms, for example, —P(R^{P})₂), a (meth)acryloyl group, a (meth)acryloyloxy group, a (meth)acryloylimino group (a (meth)acrylamide group), a hydroxy group, a sulfanyl group, a carboxy group, a phosphate group, a phosphoric acid group, a sulfonic acid group, a cyano group, and a halogen atom (for example, a fluorine atom, a chlorine atom, a bromine atom, an iodine atom, or the like).

In addition, in the respective groups exemplified as the substituent P, the substituent P may be further substituted.

In a case in which a compound, a substituent, a linking group, and the like has an alkyl group, an alkylene group, an alkenyl group, an alkenylene group, an alkynyl group, an alkynylene group, and/or the like, the compound, the substituent, the linking group, and the like may have a cyclic shape or a chain shape, may be linear or branched, and may be substituted or unsubstituted as described above.

### (C) Dispersion Medium

The solid electrolyte composition of the embodiment of the invention contains a dispersion medium for dispersing solid components. Specific examples of the dispersion medium include dispersion media described below.

Examples of an alcohol compound solvent include methyl alcohol, ethyl alcohol, 1-propyl alcohol, 2-propyl alcohol, 2-butanol, ethylene glycol, propylene glycol, glycerin, 1,6-hexanediol, cyclohexane diol, sorbitol, xylitol, 2-methyl-2,4-pentanediol, 1,3-butanediol, and 1,4-butanediol.

As an ether compound solvent, alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, methylene glycol, polyethylene glycol, propylene glycol dimethyl ether, dipropylene glycol monomethyl ether, tripropylene glycol monomethyl ether, diethylene glycol monobutyl ether, diethylene glycol dibutyl ether, and the like), dialkyl ethers (dimethyl ether, diethyl ether, diisopropyl ether, dibutyl ether, and the like), alkylaryl ethers (anisole), tetrahydrofuran, dioxane (including each of 1,2-, 1,3-, and 1,4- isomers), t-butyl methyl ether, cyclohexyl methyl ether, and cyclopentyl methyl ether.

Examples of an amide compound solvent include N,N-dimethylformamide, 1-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphoric triamide.

Examples of an amino compound solvent include triethylamine, diisopropylethylamine, tributylamine, and the like.

Examples of a ketone compound solvent include acetone, methyl ethyl ketone, methyl isobutyl ketone, diisopropyl ketone, diisobutyl ketone, and cyclohexanone.

Examples of an aromatic compound solvent include benzene, toluene, xylene, and mesitylene.

Examples of an aliphatic compound solvent include hexane, heptane, cyclohexane, methylcyclohexane, octane, pentane, cyclopentane, and cyclooctane.

Examples of a nitrile compound solvent include acetonitrile, propionitrile, and butyronitrile.

The boiling point of the dispersion medium at a normal pressure (1 atmosphere) is preferably 50° C. or higher and more preferably 70° C. or higher. The upper limit is preferably 250° C. or lower and more preferably 220° C. or lower. The dispersion medium may be used singly or two or more dispersion media may be used in combination.

The dispersion medium (C) that is used in the present invention preferably has a lower boiling point than the fluorine-containing compound (B) since the film-forming property in the case of producing the solid electrolyte-containing sheet of the embodiment of the invention using the solid electrolyte composition of the embodiment of the invention is favorable and, consequently, the solid electrolyte-containing sheet of the embodiment of the invention being obtained is excellent in terms of the layer thickness uniformity. The difference in boiling point between the dispersion medium (C) and the fluorine-containing compound (B) is preferably 10° C. or more, more preferably 30° C. or more, and still more preferably 50° C. or more.

The dispersion medium (C) that is used in the present invention is, in particular, preferably an ether compound solvent, a ketone compound solvent, or a hydrocarbon solvent (an aromatic compound solvent or an aliphatic compound solvent), from the viewpoint of the stability of the inorganic solid electrolyte, more preferably a hydrocarbon solvent (an aromatic compound solvent or an aliphatic compound solvent) and still more preferably diisopropyl ether, 1,4-dioxane, toluene, xylene, or octane.

Meanwhile, the content of the dispersion medium in the solid electrolyte composition of the embodiment of the invention is not particularly limited, but is preferably 20% to 90% by mass, more preferably 30% to 85% by mass, and particularly preferably 40% to 85% by mass.

### (D) Binder

The solid electrolyte composition of the embodiment of the invention may contain (D) a binder. Hereinafter, the binder (D) will also be simply referred to as the binder.

The binder that is used in the present invention is not particularly limited as long as the binder is an organic polymer.

A binder that can be used in the present invention is not particularly limited, and, for example, a binder made of a resin described below is preferred.

Examples of a fluorine-containing resin include polytetrafluoroethylene (PTFE), polyvinylene difluoride (PVdF), and copolymers of polyvinylene difluoride and hexafluoropropylene (PVdF-HFP).

Examples of a hydrocarbon-based thermoplastic resin include polyethylene, polypropylene, styrene butadiene rubber (SBR), hydrogenated styrene butadiene rubber (HSBR), butylene rubber, acrylonitrile butadiene rubber, polybutadiene, and polyisoprene.

Examples of an acrylic resin include a variety of (meth)acrylmonomers, (meth)acrylamide monomers, and copolymers of monomers constituting these resins (preferably copolymers of acrylic acid and methyl acrylate).

In addition, copolymers with other vinyl-based monomers are also preferably used. Examples thereof include copolymers of methyl (meth)acrylate and styrene, copolymers of methyl (meth)acrylate and acrylonitrile, and copolymers of butyl (meth)acrylate, acrylonitrile, and styrene. In the present specification, a copolymer may be any of a statistic copolymer and a periodic copolymer and is preferably a blocked copolymer.

Examples of other resins include a polyurethane resin, a polyurea resin, a polyamide resin, a polyimide resin, a polyester resin, a polyether resin, a polycarbonate resin, a cellulose derivative resin, and the like.

These resins may be used singly or two or more reins may be used in combination.

The binder that is used in the present invention exhibits a strong binding property (the suppression of peeling from the collector and the improvement of the cycle service life by the binding of the solid interface) and is thus preferably at least one selected from the above-descried group consisting of an acrylic resin, a polyurethane resin, a polyurea resin, a polyimide resin, a fluorine-containing resin, and a hydrocarbon-based thermoplastic resin.

The binder that is used in the present invention preferably has a polar group in order to enhance the wettability or adsorption property into particle surfaces. The polar group is preferably a monovalent group including a hetero atom, for example, a monovalent group including a structure in which any of an oxygen atom, a nitrogen atom, and a sulfur atom and a hydrogen atom are bonded together, and specific examples thereof include a carboxy group, a hydroxy group, an amino group, a phosphate group, and a sulfo group.

The shape of the binder is not particularly limited and may be a particle shape or an irregular shape in the solid electrolyte composition, the solid electrolyte-containing sheet, or the all-solid state secondary battery.

In the present invention, the binder is preferably particles that are insoluble in the dispersion medium from the viewpoint of the dispersion stability of the solid electrolyte composition. Here, “the binder is particles that are insoluble in the dispersion medium” means that, even in a case in which the binder is added to the dispersion medium at 30° C. and left to stand for 24 hours, the average particle diameter does not decrease by 5% or more, and the degree of the decrease in the average particle diameter is preferably 3% or more and more preferably 1% or more.

Meanwhile, in a state in which the binder particles are not dissolved in the dispersion medium, the degree of the average particle diameter changed with respect to that before the addition is 0%.

In addition, the binder in the solid electrolyte composition preferably has an average particle diameter of 10 nm to 30 μm and is more preferably nanoparticles of 10 to 1,000 nm in order to suppress a decrease in the interparticle ion conductivity of the inorganic solid electrolyte.

Unless particularly otherwise described, the average particle diameter of the binder particles that are used in the present invention and the average particle diameter of the binder described in examples refers to an average particle diameter based on measurement conditions and a definition described below.

One percent by mass of a dispersion liquid is prepared by diluting the binder particles using a random solvent (a dispersion medium that is used to prepare the solid electrolyte composition, for example, octane) in a 20 ml sample bottle. The diluted dispersion specimen is irradiated with 1 kHz ultrasonic waves for 10 minutes and then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., and the obtained volume-average particle diameter is used as the average particle diameter. Regarding other detailed conditions and the like, the description of JTS Z8828:2013 “Particle size analysis-Dynamic light scattering method” is referred to as necessary. Five specimens are produced and measured per level, and the average values thereof are employed.

Meanwhile, the average particle diameter can be measured from the produced all-solid state secondary battery by, for example, disassembling the battery, peeling the electrodes off, then, measuring the average particle diameters of the electrode materials according to the above-described method for measuring the average particle diameter of the polymer particles, and excluding the measurement value of the average particle diameter of particles other than the polymer particles which has been measured in advance,

Meanwhile, as the binder that is used in the present invention, a commercially available product can be used. In addition, the binder can also be prepared using an ordinary method.

The moisture concentration of a polymer constituting the binder that is used in the present invention is preferably 100 ppm (mass-based) or less.

In addition, the polymer constituting the binder that is used in the present invention may be used in a solid state or may be used in a state of a polymer particle dispersion liquid or a polymer solution.

The mass-average molecular weight of the polymer constituting the binder that is used in the present invention is preferably 10,000 or more, more preferably 20,000 or more, and still more preferably 30,000 or more. The upper limit is preferably 1,000,000 or less, more preferably 200,000 or less, and still more preferably 100,000 or less.

In a case in which a favorable decreasing property of the interface resistance and the maintaining property thereof in the case of being used in the all-solid state secondary battery are taken into account, the content of the binder in the solid electrolyte composition is preferably 0.01 % by mass or more, more preferably 0.1 % by mass or more, and still more preferably 0.5% by mass or more with respect to 100% by mass of the solid components. From the viewpoint of battery characteristics, the upper limit is preferably 10% by mass or less, more preferably 8% by mass or less, and still more preferably 5% by mass or less.

In the present invention, the mass ratio of the total mass (total amount) of the inorganic solid electrolyte and the active material to the mass of the binder [(the mass of the inorganic solid electrolyte and the mass of the active material)/the mass of the binder] is preferably in a range of 1,000 to 1. Furthermore, this ratio is more preferably 500 to 2 and still more preferably 100 to 10.

### (E) Active Materials

The solid electrolyte composition of the embodiment of the invention may also contain (E) an active material capable of intercalating and deintercalating ions of metal elements belonging to Group I or II of the periodic table. Hereinafter, (E) the active material will also be simply referred to as the active material.

Examples of the active materials include positive electrode active materials and negative electrode active materials, and transition metal oxides that are positive electrode active materials or metal oxides that are negative electrode active materials are preferred.

In the present invention, the solid electrolyte composition containing the active material (a positive electrode active material or a negative electrode active material) will be referred to as a composition for an electrode (a composition for a positive electrode or a composition for a negative electrode).

### Positive Electrode Active Material

A positive electrode active material that the solid electrolyte composition of the embodiment of the invention may contain is preferably a positive electrode active material capable of reversibly intercalating and deintercalating lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₂F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal oxides having a bedded salt-type structure (MA) is preferred, and LCO, NCA, or NMC is more preferred.

The shape of the positive electrode active material is not particularly limited, but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instalment LA-920 (trade name, manufactured by Horiba Ltd.).

The positive electrode active material may be used singly or two or more positive electrode active materials maybe used in combination.

In the case of forming a positive electrode active material layer, the mass (mg) of the positive electrode active material per unit area (cm²) of the positive electrode active material layer (weight per unit area) is not particularly limited and can be appropriately determined depending on the set battery capacity.

The content of the positive electrode active material in the solid electrolyte composition is not particularly limited, but is preferably 10% to 95% by mass, more preferably 30% to 90% by mass, still more preferably 50% to 85% by mass, and particularly preferably 55% to 80% by mass with respect to a solid content of 100% by mass.

### Negative Electrode Active Material

A negative electrode active material that the solid electrolyte composition of the embodiment of the invention may contain is preferably a negative electrode active material capable of reversibly intercalating and deintercalating lithium ions. The above-described material is not particularly limited as long as the material has the above-described characteristics, and examples thereof include carbonaceous materials, metal oxides such as tin oxide, silicon oxide, metal complex oxides, a lithium single body, lithium alloys such as lithium aluminum alloys, metals capable of forming alloys with lithium such as Sn, Si, Al, and In and the like. Among these, carbonaceous materials or metal complex oxides are preferably used in terms of reliability. In addition, the metal complex oxides are preferably capable of absorbing and deintercalating lithium. The materials are not particularly limited, but preferably contain titanium and/or lithium as constituent components from the viewpoint of high-current density charging and discharging characteristics.

The carbonaceous material that is used as the negative electrode active material is a material substantially consisting of carbon. Examples thereof include petroleum pitch, carbon black such as acetylene black (AB), graphite (natural graphite, artificial graphite such as highly oriented pyrolytic graphite), and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, fiat graphite, and the like.

The metal oxides and the metal complex oxides being applied as the negative electrode active material are particularly preferably amorphous oxides, and furthermore, chalcogenides which are reaction products between a metal element and an element belonging to Group XVI of the periodic table are also preferably used. The amorphous oxides mentioned herein refer to oxides having a broad scattering band having a peak of a 2θ value in a range of 20° to 40°in an X-ray diffraction method in which CuKα rays are used and may have crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₈Bi₂O₃, Sb₂O₈Si₂O₃, Bi₂O₄, SnSiO₃, GeS, SnS, SnS₂, PbS, PbS₂, Sb₂S₃, Sb₂S₅, and SnSiS₃. in addition, these amorphous oxides may be complex oxides with lithium oxide, for example, Li₂SnO₂.

The negative electrode active material preferably contains a titanium atom. More specifically, Li₄Ti₅O₁₂ (lithium titanium oxide [LTO]) is preferred since the volume fluctuation during the absorption and deintercalation of lithium ions is small, and thus the high-speed charging and discharging characteristics are excellent, and the deterioration of electrodes is suppressed, whereby it becomes possible to improve the service lives of lithium ion secondary batteries.

In the present invention, a Si-based negative electrode is also preferably applied. Generally, a Si negative electrode is capable of absorbing a larger number of Li ions than a carbon negative electrode (graphite, acetylene black, or the like). That is, the amount of Li ions absorbed per unit mass increases. Therefore, it is possible to increase the battery capacity. As a result, there is an advantage that the battery driving duration can be extended.

The shape of the negative electrode active material is not particularly limited, but is preferably a particle shape. The average particle diameter of the negative electrode active material is preferably 0.1 μm to 60 μm. In order to provide a predetermined particle diameter, an ordinary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind power classifier, or the like depending on the necessity. Both of dry-type classification and wet-type classification can be carried out. The average particle diameter of negative electrode active material particles can be measured using the same method as the method for measuring the volume-average particle diameter of the positive electrode active material.

The chemical formulae of the compounds obtained using a firing method can be computed using an inductively coupled plasma (ICP) emission spectroscopic analysis method as a measurement method from the mass difference of powder before and after firing as a convenient method.

The negative electrode active material may be used singly or two or more negative electrode active materials may be used in combination.

In the case of forming a negative electrode active material layer, the mass (mg) of the negative electrode active material per unit area (cm²) in the negative electrode active material layer (weight per unit area) is not particularly limited and can be appropriately determined depending on the set battery capacity.

The content of the negative electrode active material in the solid electrolyte composition is not particularly limited, but is preferably 10% to 80% by mass and more preferably 20% to 80% by mass with respect to a solid content of 100% by mass.

The surfaces of the positive electrode active material and/or the negative electrode active material may be coated with a separate metal oxide. Examples of the surface coating agent include metal oxides and the like containing Ti, Nb, Ta, W, Zr, Al, Si, or Li. Specific examples thereof include titanium oxide spinel, tantalum-based oxides, niobium-based oxides, lithium niobate-based compounds, and the like, and specific examples thereof include Li₄Ti₅O₁₂, Li₂Ti₂O₅, LiTaO₃, LiNbO₃, LiAlO₂, Li₂ZrO₃, Li₂WO₄, Li₂TiO₃, Li₂B₄O₇, Li₃PO₄, Li₂MoO₄, Li₃BO₃, LiBO₂, Li₂CO₃, Li₂SiO₃, SiO₂, TiO₂, ZrO₂, Al₂O₃, B₂O₃, and the like.

In addition, a surface treatment may be carried out on the surfaces of electrodes including the positive electrode active material or the negative electrode active material using sulfur, phosphorous, or the like.

Furthermore, the particle surfaces of the positive electrode active material or the negative electrode active material may be treated with an active light ray or an active gas (plasma or the like) before or after the coating of the surfaces.

### Dispersant

The solid electrolyte composition of the embodiment of the invention may also contain a dispersant. The addition of the dispersant enables the suppression of the agglomeration of the electrode active material and the inorganic solid electrolyte even in a case in which the concentration of any of the electrode active material and the inorganic solid electrolyte is high or a case in which the particle diameters are small and the surface area increases and the formation of a uniform active material layer and a uniform solid electrolyte layer. As the dispersant, a dispersant that is generally used for an all-solid state secondary battery can be appropriately selected and used. Generally, a compound intended for particle adsorption and steric repulsion and/or electrostatic repulsion is preferably used.

### Lithium Salt

The solid electrolyte composition of the embodiment of the invention may also contain a lithium salt.

The lithium salt is not particularly limited, and, for example, the lithium salt described in Paragraphs 0082 to 0085 of JP2015-088486A is preferred.

The content of the lithium salt is preferably 0 parts by mass or more and more preferably 5 parts by mass or more with respect to 100 parts by mass of the inorganic solid electrolyte. The upper limit is preferably 50 parts by mass or less and more preferably 20 parts by mass or less.

### Conductive Auxiliary Agent

The solid electrolyte composition of the embodiment of the invention may also contain a conductive auxiliary agent. The conductive auxiliary agent is not particularly limited, and conductive auxiliary agents that are known as ordinary conductive auxiliary agents can be used. The conductive auxiliary agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene which are electron-conductive materials and also may be metal powder or a metal fiber of copper, nickel, or the like, and a conductive polymer such as polyaniline, polypyrrole, polythiophene, polyacetylene, or a polyphenylene derivative may also be used. In addition, these conductive auxiliary agents may be used singly or two or more conductive auxiliary agents may be used.

### Preparation of Solid Electrolyte Composition

The solid electrolyte composition of the embodiment of the invention can be prepared by dispersing the inorganic solid electrolyte (A) in the presence of the dispersion medium (C) to produce a slurry.

The slurry can be produced by mixing the inorganic solid electrolyte and the dispersion medium using a variety of mixers. The mixing device is not particularly limited, and examples thereof include a ball mill, a beads mill, a planetary mixer, a blade mixer, a roll mill, a kneader, and a disc mill. The mixing conditions are not particularly limited; however, in the case of using a ball mill, the inorganic solid electrolyte and the dispersion medium are preferably mixed together at 150 to 700 rpm (rotation per minute) for one hour to 24 hours.

In the case of preparing a solid electrolyte composition containing components such as an active material and a particle dispersant, the components may be added and mixed at the same time as a dispersion step of the inorganic solid electrolyte (A) or may be separately added and mixed. Meanwhile, the fluorine-containing compound (B) may be added and mixed at the same time as the dispersion step of the components such as the inorganic solid electrolyte (A) and/or the active material and the particle dispersant or may be separately added and mixed.

### Solid Electrolyte-Containing Sheet

A solid electrolyte-containing sheet of the embodiment of the invention has a layer containing (A) an inorganic solid electrolyte having a conductivity for ions of metals belonging to Group I or II of the periodic table and (B) the fluorine-containing compound satisfying all of the conditions b1 to b4.

The solid electrolyte-containing sheet of the embodiment of the invention, particularly, the solid electrolyte-containing sheet of the embodiment of the invention that is produced using the solid electrolyte composition of the embodiment of the invention is excellent in terms of the uniformity of the layer thickness. As a result, an all-solid state secondary battery into which the solid electrolyte-containing sheet of the embodiment of the invention is combined is considered to exhibit an effect that is excellent in terms of a short-circuit suppression effect.

In addition, in the solid electrolyte-containing sheet of the embodiment of the invention, the fluorine-containing compound (B) is assumed to exhibit a hydrophobic effect without forming a chemical bond or the like with the inorganic solid electrolyte (A). That is, it is assumed that, during the storage period of the solid electrolyte-containing sheet of the embodiment of the invention, it is possible to suppress the decomposition of the inorganic solid electrolyte (A) by moisture in the atmosphere such as moisture, and it is possible to maintain the uniformity of the layer thickness of the solid electrolyte-containing sheet even during the storage period. Particularly, the sulfide-based inorganic solid electrolyte is likely to react with moisture and generates hydrogen sulfide by being decomposed, and thus it is possible to suppress the unevenness of the film thickness of the solid electrolyte-containing sheet caused by the generation of hydrogen sulfide. In addition, the solid electrolyte-containing sheet of the embodiment of the invention is considered to be capable of improving the water resistance while suppressing a decrease in the ion conductivity caused by the addition of the fluorine-containing compound (B) to the minimum extent,

The solid electrolyte-containing sheet of the embodiment of the invention can be preferably used in all-solid state secondary batteries and is modified in a variety of aspects depending on the uses. Examples thereof include a sheet that is preferably used in a solid electrolyte layer (also referred to as a solid electrolyte sheet for an all-solid state secondary battery), a sheet that is preferably used in an electrode or a laminate of an electrode and a solid electrolyte layer (an electrode sheet for an all-solid state secondary battery), and the like. In the present invention, a variety of sheets described above will be collectively referred to as a sheet for an all-solid state secondary battery in some cases.

The sheet for an all-solid state secondary battery is a sheet having a solid electrolyte layer or an active material layer (electrode layer), and examples thereof include an aspect of a sheet having a solid electrolyte layer or an active material layer (electrode layer) on a base material and an aspect made up of a solid electrolyte layer and/or an active material layer (electrode layer) (an aspect not having a base material). Hereinafter, the sheet of this aspect will be described in detail.

This sheet for an all-solid state secondary battery may further have other layers as long as the sheet has the solid electrolyte layer or the active material layer, but a sheet containing an active material is classified into an electrode sheet for an all-solid state secondary battery described below. Examples of other layers include a protective layer, a collector, a coating layer (a collector, a solid electrolyte layer, or an active material layer), and the like.

Examples of the solid electrolyte sheet for an all-solid state secondary battery include a sheet having a solid electrolyte layer and a protective layer on a base material in this order.

The base material is not particularly limited as long as the base material is capable of supporting the solid electrolyte layer, and examples thereof include sheet bodies (plate-like bodies) of materials, organic materials, inorganic materials, and the like described in the section of the collector described below. Examples of the organic materials include a variety of polymers and the like, and specific examples thereof include polyethylene terephthalate, polypropylene, polyethylene, cellulose, and the like. Examples of the inorganic materials include glass, ceramic, and the like.

The layer thickness of the solid electrolyte layer in the sheet for an all-solid state secondary battery is identical to the layer thickness of the solid electrolyte layer described in the section of an all-solid state secondary battery of the embodiment of the invention.

This sheet is obtained by forming a film of the solid electrolyte composition of the embodiment of the invention (by means of application and drying) on the base material (possibly, through other layers) and forming a solid electrolyte layer on the base material.

Here, the solid electrolyte composition of the embodiment of the invention can be prepared using the above-described method.

An electrode sheet for an all-solid state secondary battery of the embodiment of the invention (also simply referred to as “the electrode sheet”) is a sheet for forming an active material layer in an all-solid state secondary battery and an electrode sheet having an active material layer on a metal foil as a collector. This electrode sheet is generally a sheet having a collector and an active material layer, and an aspect of having a collector, an active material layer, and a solid electrolyte layer in this order and an aspect of having a collector, an active material layer, a solid electrolyte layer, and an active material layer in this order are also considered as the electrode sheet.

The layer thicknesses of the respective layers constituting the electrode sheet are identical to the layer thicknesses of individual layers described in the section of an all-solid state secondary battery of the embodiment of the invention. In addition, the constitution of the respective layers constituting the electrode sheet is identical to the constitution of individual layers described in the section of an all-solid state secondary battery of the embodiment of the invention described below.

The electrode sheet is obtained by forming a film of the solid electrolyte composition of the embodiment of the invention which contains the active material (by means of application and drying) on the metal foil and forming an active material layer on the metal foil.

### All-Solid State Secondary Battery

An all-solid state secondary battery of the embodiment of the invention has a positive electrode, a negative electrode feeing the positive electrode, and a solid electrolyte layer between the positive electrode and the negative electrode. The positive electrode has a positive electrode active material layer on a positive electrode collector. The negative electrode has a negative electrode active material layer on a negative electrode collector.

At least one layer of the negative electrode active material layer, the positive electrode active material layer, or the solid electrolyte layer is preferably formed using the solid electrolyte composition of the embodiment of the invention.

Preferably, the kinds and the content ratio of the components of the active material layers and/or the solid electrolyte layer formed using the solid electrolyte composition are basically identical to those in the solid content of the solid electrolyte composition.

Hereinafter, a preferred embodiment of the present invention will be described with reference to FIG. 1, but the present invention is not limited thereto.

### Positive Electrode Active Material Layer, Solid Electrolyte Layer, and Negative Electrode Active Material Layer

In the all-solid state secondary battery 10, at least one of the positive electrode active material layer, the solid electrolyte layer, or the negative electrode active material layer is produced using the solid electrolyte composition of the embodiment of the invention.

That is, the solid electrolyte layer 3 is produced using the solid electrolyte composition of the embodiment of the invention, the solid electrolyte layer 3 includes the inorganic solid electrolyte (A) and the fluorine-containing compound (B). The solid electrolyte layer, generally, does not include any positive electrode active material and/or any negative electrode active material.

In a case in which the positive electrode active material layer 4 and/or the negative electrode active material layer 2 are produced using the solid electrolyte composition of the embodiment of the invention containing an active material, the positive electrode active material layer 4 and the negative electrode active material layer 2 respectively include a positive electrode active material or a negative electrode active material and further include the inorganic solid electrolyte (A) and the fluorine-containing compound (B). In a case in which the active material layers contain the inorganic solid electrolyte, it is possible to improve the ion conductivity.

The kinds of the inorganic solid electrolyte (A) and the fluorine-containing compound (B) that the positive electrode active material layer 4, the solid electrolyte layer 3, and the negative electrode active material layer 2 contain may be identical to or different from each other.

In the present invention, any layer of the negative electrode active material layer, the positive electrode active material layer, and the solid electrolyte layer in the all-solid state secondary battery is produced using the solid electrolyte composition containing the inorganic solid electrolyte (A) and the fluorine-containing compound (B) and is a layer containing the inorganic solid electrolyte (A) and the fluorine-containing compound (B).

The all-solid state secondary battery of the embodiment of the invention, particularly, the all-solid state secondary battery of the embodiment of the invention which is produced using the solid electrolyte composition of the embodiment of the invention exhibits a high battery voltage. This is considered to be because the layer containing die inorganic solid electrolyte (A) and the fluorine-containing compound (B) has a high layer thickness uniformity. Particularly, in the case of being produced using the solid electrolyte composition after being stored or the solid electrolyte-containing sheet after being stored, in the all-solid state secondary battery of the embodiment of the invention, it is considered that the generation of pores (voids) in the inorganic solid electrolyte and the unevenness of the layer thickness which are caused by the decomposition of the inorganic solid electrolyte is suppressed, and short-circuit is effectively suppressed.

### Collector (Metal Foil)

The positive electrode collector 5 and the negative electrode collector 1 are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred, and, among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred, and aluminum, copper, a copper alloy, or stainless steel is more preferred.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 to 500 μm. In addition, the surface of the collector is preferably provided with protrusions and recesses by means of a surface treatment.

In the present invention, a functional layer, member, or the like may be appropriately interposed or disposed between the respective layers of the negative electrode collector, the negative electrode active material layer, the solid electrolyte layer, the positive electrode active material layer, and the positive electrode collector or on the outside thereof. In addition, the respective layers may be composed of a single layer or multiple layers,

### Chassis

It is possible to produce the basic structure of the all-solid state secondary battery by disposing the respective layers described above. Depending on the use, the basic structure may be directly used as an all-solid state secondary battery, but the basic structure may be used after being enclosed in an appropriate chassis in order to have a dry battery form. The chassis may be a metallic chassis or a resin (plastic) chassis. In a case in which a metallic chassis is used, examples thereof include an aluminum alloy chassis and a stainless-steel chassis. The metallic chassis is preferably classified into a positive electrode-side chassis and a negative electrode-side chassis and electrically connected to the positive electrode collector and the negative electrode collector respectively. The positive electrode-side chassis and the negative electrode-side chassis are preferably integrated by being joined together through a gasket for short circuit prevention.

### Manufacturing of Solid Electrolyte-Containing Sheet

The solid electrolyte-containing sheet of the embodiment of the invention is obtained by forming a film of the solid electrolyte composition of the embodiment of the invention on a base material (possibly, through a different layer) (application and drying) and forming a solid electrolyte layer on the base material.

With the above-described aspect, it is possible to produce a solid electrolyte-containing sheet having the inorganic solid electrolyte (A) and the fluorine-containing compound (B) on a base material.

Additionally, regarding steps such as application, it is possible to use a method described in the following section of the manufacturing of an all-solid state secondary battery.

Meanwhile, the solid electrolyte-containing sheet may also contain (C) a dispersion medium as long as the battery performance is not affected. Specifically, the content of the dispersion medium may be 1 ppm or more and 10,000 ppm or less of the total mass.

Meanwhile, the content proportion of the dispersion medium (C) in the solid electrolyte-containing sheet of the embodiment of the invention can be measured using the following method.

A 20 mm×20 mm specimen was cut out from the solid electrolyte-containing sheet by punching and immersed in heavy tetrahydrofuran in a glass bottle. The obtained eluted substance is filtered using a syringe filter, and a quantitative operation by ¹H-NMR is earned out. The correlation between the ¹H-NMR peak surface area and the amount of the solvent is obtained by producing a calibration curve.

### All-Solid State Secondary Battery and Manufacturing of Electrode Sheet for All-Solid State Secondary Battery

The all-solid state secondary battery and the electrode sheet for an all-solid state secondary battery can be manufactured using an ordinary method. Specifically, the all-solid state secondary battery and the electrode sheet for an all-solid state secondary battery can be manufactured by forming the respective layers described above using the solid electrolyte composition of the embodiment of the invention or the like. Hereinafter, the manufacturing method will be described in detail.

The all-solid state secondary battery of the embodiment of the invention can be manufactured using a method including (through) a step of applying the solid electrolyte composition of the embodiment of the invention onto a base material (for example, a metal foil which serves as a collector) and forming a coated film (film manufacturing).

For example, a solid electrolyte composition containing a positive electrode active material is applied as a material for a positive electrode (a composition for a positive electrode) onto a metal foil which is a positive electrode collector so as to form a positive electrode active material layer, thereby producing a positive electrode sheet for an all-solid state secondary battery. Next, a solid electrolyte composition for forming a solid electrolyte layer is applied onto the positive electrode active material layer so as to form a solid electrolyte layer. Furthermore, a solid electrolyte composition containing a negative electrode active material is applied as a material for a negative electrode (a composition for a negative electrode) onto the solid electrolyte layer so as to form a negative electrode active material layer. A negative electrode collector (a metal foil) is overlaid on the negative electrode active material layer, whereby it is possible to obtain an all-solid state secondary battery having a structure in which the solid electrolyte layer is sandwiched between the positive electrode active material layer and the negative electrode active material layer. A desired all-solid state secondary battery can be produced by enclosing the all-solid state secondary battery in a chassis as necessary.

In addition, it is also possible to manufacture an all-solid state secondary battery by carrying out the methods for forming the respective layers in a reverse order so as to form a negative electrode active material layer, a solid electrolyte layer, and a positive electrode active material layer on a negative electrode collector and overlaying a positive electrode collector thereon.

As another method, the following method can be exemplified. That is, a positive electrode sheet for an all-solid state secondary battery is produced as described above. In addition, a solid electrolyte composition containing a negative electrode active material is applied as a material for a negative electrode (a composition for a negative electrode) onto a metal foil which is a negative electrode collector so as to form a negative electrode active material layer, thereby producing a negative electrode sheet for an all-solid state secondary battery. Next, a solid electrolyte layer is formed on the active material layer in any one of these sheets as described above. Furthermore, the other one of the positive electrode sheet for an all-solid state secondary battery and the negative electrode sheet for an all-solid state secondary battery is laminated on the solid electrolyte layer so that the solid electrolyte layer and the active material layer come into contact with each other. An all-solid state secondary battery can be manufactured as described above.

As still another method, the following method can be exemplified. That is, a positive electrode sheet for an all-solid state secondary battery and a negative electrode sheet for an all-solid state secondary battery are produced as described above. In addition, separately from the positive electrode sheet for an all-solid state secondary battery and the negative electrode sheet for an all-solid state secondary battery, a solid electrolyte composition is applied onto a base material, thereby producing a solid electrolyte sheet for an all-solid state secondary battery consisting of a solid electrolyte layer. Furthermore, the positive electrode sheet for an all-solid state secondary battery and the negative electrode sheet for an all-solid state secondary battery are laminated together so as to sandwich the solid electrolyte layer that has been peeled off from the base material. An all-solid state secondary battery can be manufactured as described above.

An all-solid state secondary battery can be manufactured by combining the above-described forming methods. For example, a positive electrode sheet for an all-solid state secondary battery, a negative electrode sheet for an all-solid state secondary battery, and a solid electrolyte sheet for an all-solid state secondary battery are produced respectively. Next, a solid electrolyte layer peeled off from a base material is laminated on the negative electrode sheet for an all-solid state secondary battery and is then attached to the positive electrode sheet for an all-solid state secondary battery, whereby an all-solid state secondary battery can be manufactured. In this method, it is also possible to laminate the solid electrolyte layer on the positive electrode sheet for an all-solid state secondary battery and attach the solid electrolyte layer to the negative electrode sheet for an all-solid state secondary battery.

### Formation of Individual Layers (Film Formation)

The method for applying the solid electrolyte composition is not particularly limited and can be appropriately selected. Examples thereof include coating (preferably wet-type coating), spray coating, spin coating, dip coating, slit coating, stripe coating, and bar coating.

At this time, the solid electrolyte composition may be dried after being applied or may be dried after being applied to multiple layers, it is preferable to prevent the fluorine-containing compound (B) from being evaporated and completely removed from the respective layers by this drying treatment. The drying temperature is not particularly limited. The lower limit is preferably 30° C. or higher, more preferably 60° C. or higher, and still more preferably 80° C. or higher, and the upper limit is preferably 300° C. or lower, more preferably 250° C. or lower, and still more preferably 200° C. or lower. In a case in which the compositions are heated in the above-described temperature range, it is possible to remove the dispersion medium and form a solid state. In addition, the temperature is not excessively increased, and the respective members of the all-solid state secondary battery are not impaired, which is preferable. Therefore, in the all-solid state secondary battery, excellent total performance is exhibited, and it is possible to obtain a favorable binding property,

After the production of the applied solid electrolyte composition or the all-solid state secondary battery, the respective layers or the all-solid state secondary battery is preferably pressurized. In addition, the respective layers are also preferably pressurized in a state of being laminated together. Examples of the pressurization method include a hydraulic cylinder pressing machine and the like. The welding pressure is not particularly limited, but is, generally, preferably in a range of 50 to 1,500 MPa.

In addition, the applied solid electrolyte composition may be heated at the same time as pressurization. The heating temperature is not particularly limited, but is generally in a range of 30° C. to 300° C. The respective layers or the all-solid state secondary battery can also be pressed at a temperature higher than the glass transition temperature of the inorganic solid electrolyte.

The pressurization may be carried out in a state in which the applied solvent or dispersion medium has been dried in advance or in a state in which the solvent or the dispersion medium remains.

Meanwhile, the respective compositions may be applied at the same time, and the application, the drying, and the pressing may be carried out simultaneously and/or sequentially. The respective compositions may be applied to separate base materials and then laminated by means of transfer.

The atmosphere during the pressurization is not particularly limited and may be any one of in the atmosphere, under the dried air (the dew point: −20° C. or lower), in an inert gas (for example, in an argon gas, in a helium gas, or in a nitrogen gas), and the like.

The pressing time may be a short time (for example, within several hours) at a high pressure or a long time (one day or longer) under the application of an intermediate pressure. In the case of members other than the sheet for an all-solid state secondary battery, for example, the all-solid state secondary battery, it is also possible to use a restraining device (screw fastening pressure or the like) of the all-solid state secondary battery in order to continuously apply an intermediate pressure.

The pressing pressure may be a pressure that is constant or varies with respect to a portion under pressure such as a sheet surface.

The pressing pressure can be changed depending on the area or film thickness of the portion under pressure, in addition, it is also possible to change the same portion with a pressure that varies stepwise.

A pressing surface may be flat or roughened.

### Initialization

The all-solid state secondary battery manufactured as described above is preferably initialized after the manufacturing or before the use. The initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

### Usages of All-Solid State Secondary Battery

The all-solid state secondary battery of the embodiment of the invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles (electric cars and the like), electric vehicles, motors, lighting equipment, toys, game devices, road conditioners, watches, strobes, cameras, medical devices (pacemakers, hearing aids, shoulder massage devices, and the like), and the like. Furthermore, the ail-solid state secondary battery can be used for a variety of military usages and universe usages. In addition, the all-solid state secondary battery can also be combined with solar batteries.

According to the preferred embodiment of the present invention, individual application forms as described below are derived.
[1]All-solid state secondary batteries in which at least one layer of a positive electrode active material layer, a solid electrolyte layer, or a negative electrode active material layer contains a lithium salt.
[2]Methods for manufacturing an all-solid state secondary battery in which a solid electrolyte layer is formed by applying a slurry including a lithium salt and a sulfide-based inorganic solid electrolyte dispersed using a dispersion medium in a wet manner.
[3]Solid electrolyte compositions containing an active material for producing the all-solid state secondary battery.
[4]Electrode sheets for a battery obtained by applying the solid electrolyte composition onto a metal foil to form a film.
[5]Methods for manufacturing an electrode sheet for a battery in which the solid electrolyte composition is applied onto a metal foil, thereby forming a film.

As described in the preferred embodiments [2] and [5], preferred methods for manufacturing the all-solid state secondary battery and the electrode sheet for a battery are all wet-type processes. Therefore, even in a region in at least one layer of the positive electrode active material layer or the negative electrode active material layer in which the content of the inorganic solid electrolyte is as low as 10% by mass or less, the adhesiveness between the active material and the inorganic solid electrolyte, an efficient ion conduction path can be maintained, and it is possible to manufacture an all-solid state secondary battery having a high energy density (Wh/kg) and a high output density (W/kg) per battery mass.

All-solid state secondary batteries refer to secondary batteries having a positive electrode, a negative electrode, and an electrolyte which are all composed of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (high-molecular-weight) all-solid state secondary batteries in which a high-molecular-weight compound such as polyethylene oxide is used as an electrolyte and inorganic all-solid state secondary batteries in which the Li—P—S-based glass, LLT, LLZ, or the like is used. Meanwhile, the application of organic compounds to inorganic all-solid state secondary batteries is not inhibited, and organic compounds can also be applied as binders or additives of positive electrode active materials, negative electrode active materials, and inorganic solid electrolytes.

Inorganic solid electrolytes are differentiated from electrolytes in which the above-described high-molecular-weight compound is used as an ion conductive medium (high-molecular-weight electrolyte), and inorganic compounds serve as ion conductive media. Specific examples thereof include the Li—P—S glass, LLT, and LLZ. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, in the case of being differentiated from electrolytes as the ion transportation materials, the materials are referred to as “electrolyte salts” or “supporting electrolytes”. Examples of the electrolyte salts include LiTFSI.

In the present invention, “compositions” refer to mixtures obtained by uniformly mixing two or more components. Here, compositions may partially include agglomeration or uneven distribution as long as the compositions substantially maintain uniformity and exhibit desired effects. Examples

Hereinafter, the present invention will be described in more detail on the basis of examples. Meanwhile, the present invention is not interpreted to be limited thereto. “Parts” and “%” that represent compositions in the following examples are mass-based unless particularly otherwise described. In addition, “room temperature” refers to 25° C.

### Synthesis of Sulfide-Based Inorganic Solid Electrolyte

### Synthesis of Li—P—S-Based Glass

As a sulfide-based inorganic solid electrolyte, Li—P—S-based glass was synthesized with reference to a non-patent document of T. Ohtomo, A. Hayashi, M. Tatsumisago, Y. Tsuchida, S. HamGa, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, injected into an agate mortar, and mixed using an agate muddler for five minutes. Meanwhile, the mixing ratio between Li₂S and P₂S₅ was set to 75:25 in terms of molar ratio.

Sixty six zirconia beads having a diameter of 5 mm were injected into a 45 ml zirconia container (manufactured by Fritsch Japan Co., Ltd.), the full amount of the mixture of the lithium sulfide and the diphosphorus pentasulfide was injected thereinto, and the container was sealed in an argon atmosphere. The container was set in a planetary ball mill P-7 (trade name) manufactured by Fritsch Japan Co., Ltd., mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass). The ion conductivity was 0.28 mS/cm, and the particle diameter was 20.3 μm.

### Example 1

### Preparation of Individual Compositions

### (1) Preparation of Solid Electrolyte Composition S-1

Fifty zirconia beads having a diameter of 3 mm were injected into a 45 mL zirconia container (manufactured by Fritsch Japan Co., Ltd.), an oxide-based inorganic solid electrolyte LLZ (manufactured by Toshima Manufacturing Co., Ltd.) (1.5 g), a fluorine-containing compound (B-1) (0.10 g), and a binder (E-1) (0.02 g) were added thereto, and 1,4-dioxane (5,3 g) was injected thereinto as a dispersion medium. After that, the container was set in a planetary ball mill P-7 (trade name) manufactured by Fritsch Japan Co., Ltd., the components were continuously mixed together at a temperature of 25° C. and a rotation speed of 300 rpm for two hours, thereby preparing a solid electrolyte composition S-1.

### (2) Preparation of Solid Electrolyte Composition S-2

Fifty zirconia beads having a diameter of 3 mm were injected into a 45 mL zirconia container (manufactured by Fritsch Japan Co., Ltd.), the sulfide-based inorganic solid electrolyte Li-P-S-based glass synthesized above (0.8 g), the fluorine-containing compound (B-1) (0.10 g), the binder (E-1) (0.04 g), and 1,4-dioxane (3.6 g) as a dispersion medium were injected thereinto. After that, the container was set in a planetary ball mill P-7 (trade name) manufactured by Fritsch japan Co., Ltd., and the components were continuously stirred at a temperature of 25° C. and a rotation speed of 300 rpm for two hours, thereby preparing a solid electrolyte composition S-2.

### (3) Preparation of Solid Electrolyte Compositions S-3 to S-11 and T-1 to T-4

Solid electrolyte compositions S-3 to S-11 and T-1 to T-4 were prepared using the same method as for the solid electrolyte composition S-1 or S-2 except for the fact that the compositions were changed as shown in Table 1.

The compositions of the solid electrolyte compositions are summarized in Table 1.

Here, the solid electrolyte compositions S-1 to S-11 are the solid electrolyte composition of the embodiment of the invention, and the solid electrolyte compositions T-1 to T-4 are comparative solid electrolyte compositions.

### Tests

On the solid electrolyte compositions of the examples and the comparative examples produced above, the following slurry moisture resistance test was carried out.

### Test Example 1 Slurry Moisture Resistance Test

The ion conductivity Fresh of a slurry of the solid electrolyte composition that had been immediately produced was measured using the following method.

In addition, the slurry (10 ml) of the solid electrolyte composition that had been immediately produced was put into a sample bottle (height: 150 mm, diameter: 12 mm, manufactured by As One Corporation, trade name: centrifuge tube (ECK-15 mL)) and was left to stand in a state of being lidded under a condition of a dew point of −50° C. at 25° C. for one week. The ion conductivity 1 week of the slurry of the solid electrolyte composition that had been stored for one week was measured using the following method.

The retention of the ion conductivity was computed using the following expression, and the slurry moisture resistance was evaluated using the following standards. The rankings of A and B are the passing levels.

Retention of ion conductivity=ion conductivity 1 week/ion conductivity Fresh

### Evaluation standards

A: 0.9<retention of ion conductivity≤1.0

B: 0.7<retention of ion conductivity≤0.9

C: 0.5<retention of ion conductivity≤0.7

D: 0.1<retention of ion conductivity≤0.5

E: Retention of ion conductivity≤0.1

### Measurement of ion conductivity

### Production of Sample for Measuring Ion Conductivity

The solid electrolyte composition was applied onto a 20 μm-thick aluminum foil using an applicator (trade name: SA-201 Baker type applicator, manufactured by Tester Sangyo Co., Ltd.) and heated at 60° C. for two hours under a condition of a dew point of −80° C., thereby drying the applied solid electrolyte composition. After that, the dried solid electrolyte composition was heated and pressurized using a heat pressing machine at a temperature of 80° C. and a pressure of 600 MPa for 10 seconds so as to obtain a predetermined density, thereby obtaining a sample sheet for measurement (solid electrolyte-containing sheet) having a solid electrolyte layer laminated on the aluminum foil. The film thickness of the sample sheet for measurement was 50 μm.

A disc-like piece having a diameter of 14.5 mm was cut out from the produced sample sheet for measurement, and this sample sheet for measurement 15 was put into a coin case 14 illustrated in FIG. 2, Specifically, an aluminum foil cut out to a disc shape having a diameter of 15 mm (not illustrated in FIG. 2) was brought into contact with the solid electrolyte layer, a spacer and a washer (both are not illustrated in FIG. 2) were combined thereinto, and the laminate was put into a stainless steel 2032-type coin case 14. The coin case was swaged with a screw S, thereby producing a sample for measuring the ion conductivity 13.

The ion conductivity was measured using the sample for measuring the ion conductivity obtained above. Specifically, the alternating-current impedance was measured in a constant-temperature tank (30° C.) using a 1255B FREQUENCY RESPONSE ANALYZER (trade name) manufactured by SOLARTRON Analytical at a voltage magnitude of 5 mV and a frequency of 1 MHz to 1 Hz. Therefore, the resistance of the specimen in the film thickness direction was obtained, and the ion conductivity was computed.

Ion conductivity (mS/cm)=
1000×specimen film thickness (cm)/(resistance(Ω)×specimen area (cm²))

TABLE 1

| | (A) | | | | | | | | | | | |
|---|---|---|---|---|---|---|---|---|---|---|---|---|
| | Inorganic solid | | | | | | | | | | | |
| Solid | electrolyte | | (B) Fluorine-containing compound | | | | (C) Dispersion medium | | | (D) Binder | | Slurry |
| electrolyte | | Parts by | | N_{F}/ | Molecular | Parts by | | Boiling point | Parts by | | Parts by | moisture |
| composition | Kind | mass | Kind | N_{ALL} | weight | mass | Kind | (° C.) | mass | Kind | mass | resistance |
| S-1 | LLZ | 1.5 | (b-1) | 0.64 | 462 | 0.10 | 1,4-dioxane | 101 | 5.3 | (E-1) | 0.02 | A |
| S-2 | Li-P-S | 0.8 | (b-1) | 0.64 | 462 | 0.10 | 1,4-dioxane | 101 | 3.6 | (E-1) | 0.04 | B |
| S-3 | Li-P-S | 0.8 | (b-2) | 0.44 | 272 | 0.10 | Diisopropyl ether | 68 | 3.6 | (E-2) | 0.04 | B |
| S-4 | Li-P-S | 0.8 | (b-3) | 0.33 | 2791 | 0.10 | Normal heptane | 98 | 3.6 | (E-1) | 0.04 | A |
| S-5 | Li-P-S | 0.8 | (b-4) | 0.24 | 1160 | 0.04 | Toluene | 110.6 | 3.6 | (E-2) | 0.04 | A |
| S-6 | Li-P-S | 0.8 | (b-5) | 0.30 | 3105 | 0.04 | Toluene | 110.6 | 3.6 | (E-3) | 0.04 | A |
| S-7 | Li-P-S | 1.5 | (b-6) | 0.32 | 1509 | 0.04 | Normal heptane | 140 | 4.3 | (E-4) | 0.04 | A |
| S-8 | Li-P-S | 1.5 | (b-7) | 0.35 | 2665 | 0.04 | m-xylene | 140 | 4.3 | (E-5) | 0.04 | A |
| S-9 | Li-P-S | 1.5 | (b-3) | 0.33 | 2791 | 0.02 | Normal octane | 125 | 5.3 | — | — | A |
| S-10 | Li-P-S | 1.5 | (b-3) | 0.33 | 2791 | 0.02 | Normal heptane | 149 | 5.3 | (E-4) | 0.04 | A |
| S-11 | Li-P-S | 1.5 | (b-3) | 0.33 | 2791 | 0.02 | Cyclooctane | 149 | 5.3 | (E-5) | 0.04 | A |
| T-1 | LLZ | 1.5 | — | — | — | — | Normal heptane | 98 | 5.8 | (E-1) | 0.04 | C |
| T-2 | Li-P-S | 1.5 | — | — | — | — | Normal heptane | 98 | 5.8 | (E-1) | 0.04 | E |
| T-3 | Li-P-S | 1.5 | 2- | 0.05 | 172 | 0.10 | m-xylene | 140 | 5.8 | (E-2) | 0.04 | E |
| | | | Fluorobiphenyl | | | | | | | | | |
| T-4 | Li-P-S | 1.5 | 1,1,2,2,3,3,4- | 0.47 | 196 | 1.0 | Normal heptane | 98 | 4.8 | — | — | D |
| | | | Heptafluoro- | | | | | | | | | |
| | | | cyclopentane | | | | | | | | | |

<Notes of table>
(A) Inorganic solid electrolyte
LLZ: Li₇La₃Zr₂O₁₂ (manufactured by Toshima Manufacturing Co., Ltd.)
Li/P/S: Li-P-S-based glass synthesized above
(B) Fluorine-containing compound
(b-1): Octadecafluorodecahydronaphthalene (at a normal pressure, the boiling point was −10° C., and the boiling point was 142° C.)
(b-2): Octafluoronaphthalene (at a normal pressure, the boiling point was 86° C., and the boiling point was 209° C.)
(b-3) to (b-7): Compounds illustrated below (here, for all of the compounds, the boiling point or the thermal decomposition initiation temperature at a normal pressure is 300° C. or higher.)

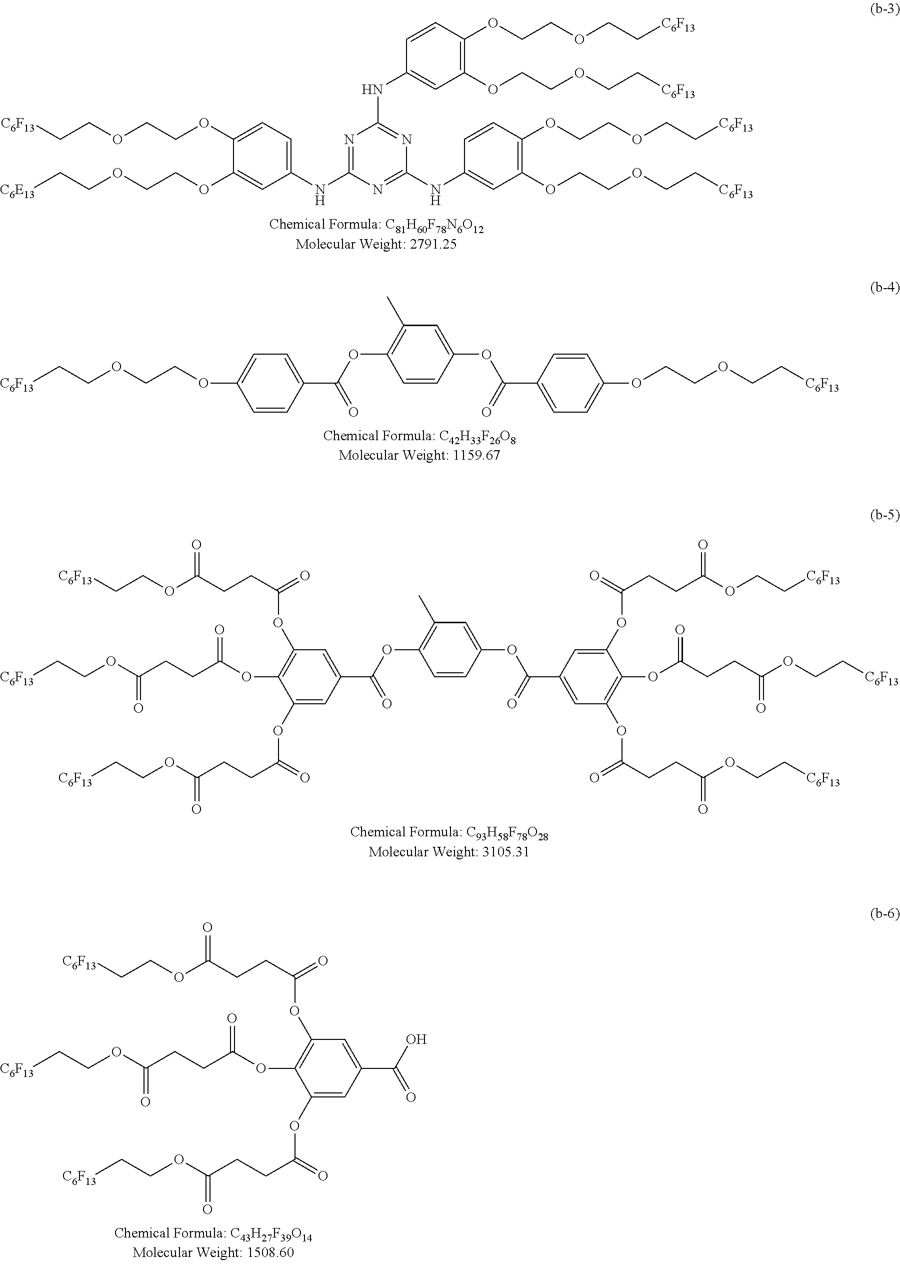

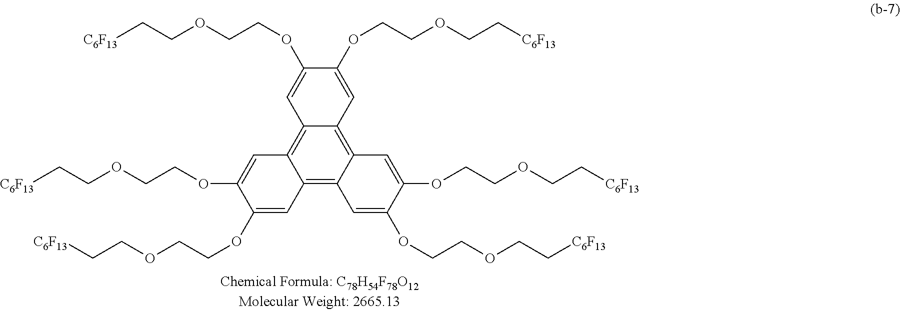

1,1,2,2,3,3,4-Heptafluorocyclopentane (at a normal pressure, the boiling point is 83° C., and the thermal decomposition initiation temperature is 300° C.)

### (D) Binder

E-1: PVdF-HFP (manufactured by Arkema S. A., a copolymer of polyvinylene difluoride and hexafluoropropylene)

E-2: SBR (manufactured by JSR Corporation, styrene butadiene rubber)

E-3: An acrylic acid-methyl acrylate copolymer prepared using the following method (20/80 molar ratio, mass-average molecular weight: 25,000)

Acrylic acid (manufactured by Wako Pure Chemical Industries, Ltd.) (1.2 g) and methyl acrylate (4.2 g) (manufactured by Wako Pure Chemical Industries, Ltd.) were dissolved in methyl ethyl ketone (MEK) (30 g) in a 100 mL three-neck flask and were substituted with nitrogen while being heated to 75° C. and stirred. Azoisobutyronitrile (V-60: trade name, manufactured by Wako Pure Chemical Industries, Ltd.) (0.15 g) was added this solution, and the solution was heated and stirred at 75° C. for six hours in a nitrogen atmosphere. For the obtained polymer solution, the polymer was precipitated using hexane, filtered, washed with hexane, and then dried, thereby obtaining a white powder of the binder (E-3).

E-4: Acrylic latex (binder (B-1) described in JP2015-088486A, an average particle diameter: 198 nm (dispersion medium: normal heptane)

E-5: Urethane polymer (exemplary compound (44) described in JP2015-088480A, mass-average molecular weight: 16,200)

Meanwhile, the average particle diameter of the binder is shown only for the binder that was present in a particle shape in the dispersion medium.

As is clear from Table 1, the solid electrolyte compositions T-1 to T-4 which did not contain the fluorine-containing compound (B) that is regulated by the present invention were poor in terms of the moisture resistance of the slurry.

In contrast, it was found that the solid electrolyte compositions S-1 to S-11 which contained the fluorine-containing compound (B) that is regulated by the present invention were excellent in terms of the slurry moisture resistance, had an ion conductivity that decreased by aging storage to a small extent, and were excellent in terms of the storage stability.

### Preparation of Solid Electrolyte Composition for Forming Active Material Layer

A solid electrolyte composition for forming an active material layer was prepared using the obtained solid electrolyte composition.

### (1) Preparation of Solid Electrolyte Composition for Forming Positive Electrode Layer (Hereinafter, also Referred to as Composition for Positive Electrode)

Fifty zirconia beads having a diameter of 3 mm were injected into a 45 mL zirconia container (manufactured by Fritsch Japan Co., Ltd.), and the solid electrolyte composition prepared above S-1 (6.8 g) was added thereto. A positive electrode active material LCO (3.2 g) was added thereto, and then the container was set in a planetary ball mill P-7 (trade name) manufactured by Fritsch Japan Co., Ltd., and the components were continuously stirred at a temperature of 25° C. and a rotation speed of 100 rpm for 10 minutes, thereby preparing a composition for a positive electrode P-1.

### (2) Preparation of Compositions for Positive Electrode P-2 to P-11 and HP-1 to HP-4

Compositions for a positive electrode P-2 to P-11 and HP-1 to HP-4 were prepared using the same method as for the composition for a positive electrode P-l except for the feet that the composition was changed as shown in Table 2.

The compositions of the compositions for a positive electrode are summarized in Table 2.

Here, the compositions for a positive electrode P-1 to P-11 are the solid electrolyte composition of the embodiment of the invention, and the compositions for a positive electrode HP-1 to HP-4 are comparative solid electrolyte compositions.

TABLE 2

| Composition | Solid electrolyte | | Positive electrode | |
|---|---|---|---|---|
| for positive | composition | | active material | |
| electrode | Type | Parts by mass | Type | Parts by mass |
| P-1 | S-1 | 6.8 | LCO | 3.2 |
| P-2 | S-2 | 4.4 | LCO | 2.8 |
| P-3 | S-3 | 4.4 | LCO | 2.8 |
| P-4 | S-4 | 4.4 | LCO | 2.8 |
| P-5 | S-5 | 4.4 | NCA | 2.8 |
| P-6 | S-6 | 4.4 | NCA | 2.8 |
| P-7 | S-7 | 5.8 | NCA | 4.2 |
| P-8 | S-8 | 5.8 | NCA | 4.2 |
| P-9 | S-9 | 6.8 | NMC | 4.2 |
| P-10 | S-10 | 6.8 | NMC | 4.2 |
| P-11 | S-11 | 6.8 | NMC | 3.7 |
| HP-1 | T-1 | 6.8 | LCO | 4.2 |
| HP-2 | T-2 | 6.8 | LCO | 4.2 |
| HP-3 | T-3 | 6.8 | NCA | 3.2 |
| HP-4 | T-4 | 6.8 | NCA | 4.2 |

<Notes of table>
LCO: LiCoO₂ (lithium cobalt oxide)
NCA: LiNi_{0.85}Co_{0.10}Al_{0.05}O₂ (lithium nickel cobalt aluminum oxide)
NMC: LiNi_{1/3}Co_{1/3}Mn_{1/3}O₂ (lithium nickel manganese cobalt oxide)

### (3) Preparation of Solid Electrolyte Composition for Forming Negative Electrode Layer (Hereinafter, also Referred to as Composition for Negative Electrode) N-1

Fifty zirconia beads having a diameter of 3 mm were injected into a 45 mL zirconia container (manufactured by Fritsch Japan Co., Ltd.), and the solid electrolyte composition prepared above S-1 (6.8 g) was added thereto. As a negative electrode active material, graphite (3.2 g) was added thereto, and then the container was set in a planetary ball mill P-7 (trade name) manufactured by Fritsch Japan Co., Ltd., and the components were continuously stirred at a temperature of 25° C. and a rotation speed of 100 rpm for 10 minutes, thereby preparing a composition for a negative electrode N-1.

### (4) Preparation of Compositions for Negative Electrode N-2 to N-11 and HN-1 to HN-4

Compositions for a negative electrode N-2 to N-11 and HN-1 to HN-4 were prepared using the same method as for the composition for a negative electrode N-1 except for the fact that the composition was changed as shown in Table 3.

The compositions of the compositions for a negative electrode are summarized in Table 3.

Here, the compositions for a negative electrode N-1 to N-11 are the solid electrolyte composition of the embodiment of the invention, and the compositions for a negative electrode HN-1 to HN-4 are comparative solid electrolyte compositions.

TABLE 3

| Composition | Solid electrolyte | | Negative electrode | |
|---|---|---|---|---|
| for negative | composition | | active material | |
| electrode | Type | Parts by mass | Type | Parts by mass |
| N-1 | S-1 | 6.8 | Graphite | 3.2 |
| N-2 | S-2 | 4.4 | Graphite | 2.8 |
| N-3 | S-3 | 4.4 | Graphite | 2.8 |
| N-4 | S-4 | 4.4 | Graphite | 2.8 |
| N-5 | S-5 | 4.4 | Graphite | 2.8 |
| N-6 | S-6 | 4.4 | Graphite | 2.8 |
| N-7 | S-7 | 5.8 | Si | 4.2 |
| N-8 | S-8 | 5.8 | Graphite | 4.2 |
| N-9 | S-9 | 6.8 | Si | 4.2 |
| N-10 | S-10 | 6.8 | Graphite | 4.2 |
| N-11 | S-11 | 6.8 | Graphite | 3.7 |
| HN-1 | T-1 | 6.8 | Graphite | 4.2 |
| HN-2 | T-2 | 6.8 | Graphite | 4.2 |
| HN-3 | T-3 | 6.8 | Graphite | 3.2 |
| HN-4 | T-4 | 6.8 | Graphite | 4.2 |

### Production of Solid Electrolyte-Containing Sheet

### (1) Production of All-Solid State Secondary Battery Positive Electrode Sheet (Hereinafter, also Referred to as Positive Electrode Sheet)

The slurry of the composition for a positive electrode P-1 was applied onto a 40 μm-thick aluminum foil using an applicator (trade name: SA-201 Baker type applicator, manufactured by Tester Sangyo Co., Ltd.) and heated at 80° C. for one hour using a heat pressing machine to remove the dispersion medium, thereby obtaining an approximately 160 μm-thick positive electrode sheet PS-1 having an approximately 120 μm-thick positive electrode active material layer.

Positive electrode sheets PS-2 to PS-11 and HPS-1 to HPS-4 were produced in the same manner.

In Table 4, positive electrode layers PS-1 to PS-11 and HPS-1 to HPS-4 indicate that positive electrode layers of all-solid state secondary batteries are respectively positive electrode layers of the positive electrode sheets PS-1 to PS-11 and HPS-1 to H PS-4.

### (2) Production of Solid Electrolyte Sheet for All-Solid State Secondary Battery (Hereinafter, also Referred to as Solid Electrolyte Sheet)

A solid electrolyte sheet SS-1 having an approximately 50 μm-thick solid electrolyte layer was produced using the solid electrolyte composition S-1 in the same manner as the positive electrode sheet PS-1. Solid electrolyte sheets SS-2 to SS-11 and HSS-1 to HSS-4 were produced in the same manner as the solid electrolyte sheet SS-1.

In Table 4, the layer thickness uniformity of the solid electrolyte layers SS-1 to SS-11 and HSS-1 to HSS-4 are respectively the evaluation results of the solid electrolyte sheets SS-1 to SS-11 and HSS-1 to HSS-4.

### (3) Production of All-Solid State Secondary Battery Negative Electrode Sheet (Hereinafter, also Referred to as Negative Electrode Sheet)

A negative electrode sheet NS-1 having an approximately 150 μm-thick negative electrode active material layer was produced in the same manner as the positive electrode sheet PS-1 using the composition for a negative electrode N-1, Negative electrode sheets NS-2 to NS-11 and HNS-1 to HNS-4 were produced in the same manner as the negative electrode sheet NS-1.

In Table 4, negative electrode layers NS-1 to NS-11 and HNS-1 to HNS-4 means that the negative electrode layers NS-1 to NS-11 and HNS-1 to HNS-4 of all-solid state secondary batteries are respectively negative electrode layers of the negative electrode sheets NS-1 to NS-11 and HNS-1 to HNS-4.

### Test

The layer thickness uniformity test (Fresh and aging storage) was carried out on the solid electrolyte-containing sheets (the positive electrode sheets, the solid electrolyte sheets, and the negative electrode sheets) produced above. Hereinafter, the testing method will be described. In addition, the results are summarized in Table 4.

### Test Example 2 Layer thickness uniformity test (Fresh)

25 mm×25 mm specimens were cut out from the obtained solid electrolyte-containing sheets by punching and were considered as samples. The layer thicknesses of these samples were measured, at nine points (three vertical points×three horizontal points) using a layer thickness meter, and the average value and standard deviation thereof at the nine points were obtained, and the layer thickness uniformity (Fresh) was evaluated using the following evaluation standards. Here, the nine points at which the layer thicknesses were measured are intersection points of two lines of 7.5 mm lines, 12.5 mm lines, and 17.5 mm lines drawn respectively from the vertical and horizontal sides of the sample.

In a case in which sheets that are obtained from the respective compositions have a uniform thickness respectively, it is possible to anticipate an effect of suppressing a decrease in the battery voltage attributed to application unevenness in the manufacturing of the sheet in the case of operating an all-solid state secondary battery into which the sheet had been combined. The rankings of A and B are the passing levels.

### Evaluation Standards

A: (Standard deviation/average)<5%

B: 5%≤(standard deviation/average)<10%

C: 10%≤( standard deviation/average)<20%

D: 20%≤(standard deviation/average)<50%

### Test Example 3 Layer thickness uniformity test (aging storage)

25 mmx25 mm specimens were cut out from the obtained solid electrolyte-containing sheets by punching and were used as samples. These samples were exposed to the atmosphere of a temperature of 25° C. and a dew point of −50° C. for one week, and then, for the exposed samples, the average value and standard deviation at nine points were obtained in the same manner as the layer thickness uniformity test (Fresh), and the layer thickness uniformity (aging storage) was evaluated using the following evaluation standards.

In a case in which the produced solid electrolyte-containing sheet has a uniform thickness at a high dew point even after being stored, at the time of operating an all-solid state secondary battery into which the sheet is combined, an effect of suppressing a short-circuit attributed to the unevenness in the layer thickness accompanied by the decomposition or the like of the inorganic solid electrolyte is anticipated, and it is possible to anticipate an effect of suppressing a decrease in the battery voltage relative to the battery voltage before storage. The rankings of A and B are the passing levels. In the following table, this test is shown as the layer thickness uniformity (aging).

### Evaluation Standards

A: (Standard deviation/average)<5%

B: 5%≤(standard deviation/average)<10%

C: 10%≤(standard deviation/average)<20%

D: 20%≤(standard deviation/average)<50%

E: 50%≤(standard deviation/average)

### Production of All-Solid State Secondary Batteries

### Production of All-Solid State Secondary Battery Sheets

The solid electrolyte composition S-1 was applied onto a TEFLON (registered trademark) sheet using an applicator (trade name: SA-201 Baker type applicator, manufactured by Tester Sangyo Co., Ltd.) and dried at 80° C. for 0.1 hours, thereby forming an approximately 50 μm-thick. solid electrolyte layer. The solid electrolyte layer side and the active material layer side of the positive electrode sheet PS-1 obtained above were attached together, and the TEFLON (registered trademark) sheet was removed. Furthermore, the solid electrolyte layer side and the active material layer side of the negative electrode sheet NS-1 obtained above were attached together and pressed using a pressing machine at 300 MPa for five seconds, thereby manufacturing an all-solid state secondary battery sheet of Test No. 101 having a layer structure illustrated in FIG. 1.

### Production of All-Solid State Secondary Battery

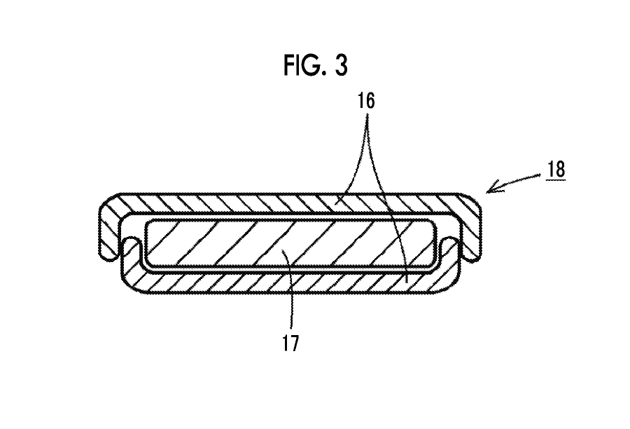

A disc-like piece having a diameter of 14.5 mm was cut out from the all-solid state secondary battery sheet 17 manufactured above, and, as illustrated in FIG. 3, the above-described cut-out all-solid state secondary battery sheet 17 was put into a stainless steel 2032-type coin case 16 which a spacer and a washer (both are not illustrated in FIG. 3) were combined into. This coin case was installed in a device illustrated in FIG. 2, and a screw S8 was swaged with a force of eight newtons (N) using a torque wrench, thereby manufacturing an all-solid state secondary battery 18 of Test No. 101.

Similarly, all-solid state secondary battery sheets and all-solid state secondary batteries of Test Nos. 102 to 111 and c101 to c104 were produced.

Here, Test Nos. 102 to 111 are the present invention, and Test Nos. c101 to c104 are comparative examples.

### Evaluation

The following voltage evaluation was carried out on the all-solid state secondary batteries of the examples and the comparative examples produced above. The evaluation results are shown in Table 4.

Meanwhile, in Table 4, the voltage evaluations of the all-solid state secondary batteries produced using the positive electrode sheets and the negative electrode sheets that were used in the layer thickness uniformity test (Fresh) were shown in the column of voltage evaluation (Fresh), and the voltage evaluations of the all-solid state secondary batteries produced using the positive electrode sheets and the negative electrode sheets that were stored under conditions of the layer thickness uniformity test (aging storage) were shown in the column of voltage evaluation (aging) respectively.

In all of the tests, for the formation of the solid electrolyte layers in the all-solid state secondary batteries, the solid electrolyte compositions immediately before the production were used.

### Test Example 4 Battery Voltage Test

The battery voltage of the all-solid state secondary battery produced above was measured using a charging and discharging evaluation device “TOSCAT-3000 (trade name)” manufactured by Toyo System Co., Ltd.

The coin battery was charged at a current density of 2 A/m² until the battery voltage reached 4.2 V, and, once the battery voltage reached 4.2 V, the coin battery was charged with constant voltage of 4.2 V until the current density reached less than 0.2 A/m². The coin battery was discharged at a current density of 2 A/m² until the battery voltage reached 3.0 V. The above-described process was considered as one cycle, the process was repeated three cycles, and the battery voltage after a 5 mAh/g discharging in the third cycle was read and evaluated using the following standards. Meanwhile, the rankings of A and B are the passing levels.

Meanwhile, a case in which short-circuit occurred at the time of the first charging and thus the discharging test could not be earned out is described as “short-circuit” in the following table.

### Evaluation standards

A: 4.0 V or more

B: 3.9 V or more and less than 4.0 V

C: 3.8 V or more and less than 3.9 V

D: 3.7 V or more and less than 3.8 V

E: Less than 3.7 V

TABLE 4

| | Positive electrode layer | | | | | Solid electrolyte layer | | | | |
|---|---|---|---|---|---|---|---|---|---|---|
| | | | | Layer thickness | | | | | Layer thickness | |
| | | Composition | Film | uniformity of | | | Composition | Film | uniformity of | |
| Test | | for positive | thickness | sheet | | | for positive | thickness | sheet | |
| Nos. | Kind | electrode | (μm) | (Fresh) | (Aging) | Kind | electrode | (μm) | (Fresh) | (Aging) |
| 101 | PS-1 | P-1 | 121 | B | B | SS-1 | S-1 | 50 | B | B |
| 102 | PS-2 | P-2 | 129 | A | A | SS-2 | S-2 | 52 | B | B |
| 103 | PS-3 | P-3 | 132 | B | B | SS-3 | S-3 | 53 | A | A |
| 104 | PS-4 | P-4 | 130 | A | A | SS-4 | S-4 | 55 | B | B |
| 105 | PS-5 | P-5 | 121 | A | A | SS-5 | S-5 | 56 | A | B |
| 106 | PS-6 | P-6 | 135 | B | B | SS-6 | S-6 | 46 | A | A |
| 107 | PS-7 | P-7 | 121 | A | B | SS-7 | S-7 | 54 | A | B |
| 108 | PS-8 | P-8 | 122 | A | A | SS-8 | S-8 | 47 | A | A |
| 109 | PS-9 | P-9 | 132 | A | A | SS-9 | S-9 | 52 | A | B |
| 110 | PS-10 | P-10 | 131 | A | B | SS-10 | S-10 | 51 | A | A |
| 111 | PS-11 | P-11 | 125 | A | A | SS-11 | S-11 | 50 | A | A |
| c101 | HPS-1 | HP-1 | 132 | C | E | HSS-1 | HS-1 | 47 | C | D |
| c102 | HPS-2 | HP-2 | 128 | D | E | HSS-2 | HS-2 | 45 | C | E |
| c103 | HPS-3 | HP-3 | 134 | C | E | HSS-3 | HS-3 | 47 | C | E |
| c104 | HPS-4 | HP-4 | 135 | C | E | HSS-4 | HS-4 | 48 | C | E |

| | Negative electrode layer | | | | | | |
|---|---|---|---|---|---|---|---|
| | | | | Layer thickness | | | |
| | | Composition | Film | uniformity of | | Battery voltage | |
| Test | | for negative | thickness | sheet | | evaluation | |
| Nos. | Kind | electrode | (μm) | (Fresh) | (Aging) | (Fresh) | (Aging) |
| 101 | NS-1 | N-1 | 151 | B | B | B | B |
| 102 | NS-2 | N-2 | 153 | B | B | B | B |
| 103 | NS-3 | N-3 | 152 | B | B | B | B |
| 104 | NS-4 | N-4 | 152 | B | B | B | B |
| 105 | NS-5 | N-5 | 149 | B | B | B | B |
| 106 | NS-6 | N-6 | 144 | B | B | B | B |
| 107 | NS-7 | N-7 | 151 | A | A | A | B |
| 108 | NS-8 | N-8 | 146 | A | A | A | A |
| 109 | NS-9 | N-9 | 147 | A | A | A | B |
| 110 | NS-10 | N-10 | 153 | A | A | A | A |
| 111 | NS-11 | N-11 | 148 | A | A | A | A |
| c101 | HNS-1 | HN-1 | 144 | C | E | D | Short-circuit |
| c102 | HNS-2 | HN-2 | 151 | D | E | E | Short-circuit |
| c103 | HNS-3 | HN-3 | 152 | C | E | E | Short-circuit |
| c104 | HNS-4 | HN-4 | 153 | C | E | E | Short-circuit |

As is clear from Table 4, the solid electrolyte-containing sheets (the positive electrode sheets, the solid electrolyte sheets, and the negative electrode sheets) of Nos. c101 to c104 which were produced from the solid electrolyte composition not containing the fluorine-containing compound (B) regulated by the present invention and did not contain the fluorine-containing compound (B) were poor in terms of the layer thickness uniformity, and the all-solid state secondary batteries not containing the fluorine-containing compound (B) were poor in terms of the battery voltage. Particularly, the solid electrolyte-containing sheets of Nos. c101 to c104 after aging storage further degraded in terms of the layer thickness uniformity, and, in the all-solid state secondary batteries in which the above-described sheets after aging storage was used, a short-circuit was caused at the first charge.

In contrast, the solid electrolyte-containing sheet (the positive electrode sheet, the solid electrolyte sheet, and the negative electrode sheet) of the embodiment of the invention which were produced from the solid electrolyte composition containing the fluorine-containing compound (B) regulated by the present invention had favorable layer thickness uniformity. In addition, the all-solid state secondary batteries which, had at least one layer produced from the solid electrolyte composition of the embodiment of the invention and contained the fluorine-containing compound (B) had a favorable battery voltage. Particularly, the solid electrolyte-containing sheets after aging storage also kept a favorable layer thickness uniformity, and, in the all-solid state secondary batteries in which the above-described sheets after aging storage was used, a short-circuit was not caused, and a favorable battery voltage was exhibited.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

### EXPLANATION OF REFERENCES

1: negative electrode collector

2: negative electrode active material layer

3: solid electrolyte layer

4: positive electrode active material layer

5: positive electrode collector

6: operation portion

10: all-solid state secondary battery

11: upper portion-supporting plate

12: lower portion-supporting plate

13: all-solid state secondary battery (sample for ion conductivity measurement)

14: coin case

15: all-solid state secondary battery sheet (sample sheet for measurement)

S: screw

16: 2032-type coin case

17: all-solid state secondary battery sheet

18: all-solid state secondary battery

What is claimed is:

1. A solid electrolyte composition comprising: (A) an inorganic solid electrolyte having a conductivity of an ion of a metal belonging to Group I or II of the periodic table;
(B) a fluorine-containing compound satisfying all of the following conditions b1 to b4; and
(C) a dispersion medium,
wherein a content of the fluorine-containing compound (B) in a total solid content of the solid electrolyte composition is 0.1% by mass or more and less than 20% by mass,
b1: as constituent atoms, a carbon atom and a fluorine atom are included, but a silicon atom is not included,
b2: N_{F}/N_{ALL} that is a ratio of the number N_{F} of fluorine atoms to the number N_{ALL} of all atoms satisfies 0.10≤N_{F}/N_{ALL}≤0.80,
b3: a molecular weight is less than 5,000, which does not apply to a polymer, and
b4: a boiling point at a normal pressure or an initiation temperature of thermal decomposition at a normal pressure exceeds 100° C., and
wherein the fluorine-containing compound (B) is solid at a normal pressure and a normal temperature.

2. The solid electrolyte composition according to claim 1,
wherein the fluorine-containing compound (B) has an aromatic ring.

3. The solid electrolyte composition according to claim 1,
wherein the fluorine-containing compound (B) is at least one selected from compounds represented by any of Formulae (1) to (3), 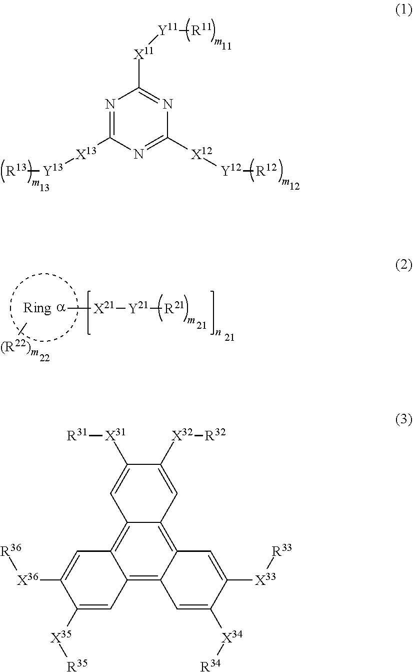
in Formula (1), R¹¹ to R¹³ each independently represent a fluorine-containing substituent or a hydrogen atom, X¹¹ to X¹³ each independently represent a single bond, an alkylene group, —O—, —S—, —C(═O)—, —NR—, or a divalent linking group formed of a combination thereof, Y¹¹ to Y¹³ each independently represent a single bond or an n-valent hydrocarbon group, m₁₁ to m₁₃ each independently represent an integer of 1 to 5, here, R represents a hydrogen atom or an alkyl group, n is m₁₁+1, m₁₂+1, or m₁₃+1, in a case in which there is a plurality of R¹¹'s, the plurality of R¹¹'s may be identical to or different from each other, in a case in which there is a plurality of R¹²'s, the plurality of R¹²'s may be identical to or different from each other, and, in a case in which there is a plurality of R¹³'s, the plurality of R¹³'s may be identical to or different from each other, here, at least one of R¹¹ to R¹³ represents a fluorine-containing substituent,
in Formula (2), a ring α represents a benzene ring or a naphthalene ring, R²¹ represents a fluorine-containing substituent or a hydrogen atom, X²¹ represents a single bond, an alkylene group, —O—, —S—, —C(═O)—, —NR—, or a divalent linking group formed of a combination thereof, Y²¹ represents a single bond or an m₂₁+1-valent hydrocarbon group, m²¹ represents an integer of 1 to 5, n²¹ represents an integer of 1 to 8, here, R represents a hydrogen atom or an alkyl group, R²² represents an organic group, m²² represents an integer of 0 to 7, in a case in which there is a plurality of R²¹'s, the plurality of R²¹'s may be identical to or different from each other, and, in a case in which there is a plurality of R²²'s, the plurality of R²²'s may be identical to or different from each other, here, at least one of R²¹'s represents a fluorine -containing substituent,
in Formula (3), R³¹ to R³⁶ each independently represent a fluorine-containing substituent or a hydrogen atom, X³¹ to X³⁶ each independently represent a single bond, an alkylene group, —O—, —S—, —C(═O)—, —NR—, or a divalent linking group formed of a combination thereof, here, R represents a hydrogen atom or an alkyl group, and, here, at least one of R³¹ to R³⁶ represents a fluorine-containing substituent.

4. The solid electrolyte composition according to claim 3,
wherein the fluorine-containing substituent is a fluorine atom, a fluorine-substituted alkyl group, a fluorine-substituted alkoxy group, or a fluorine-substituted acyloxy group.

5. The solid electrolyte composition according to claim 1,
wherein the dispersion medium (C) has a lower boiling point than the fluorine-containing compound (B).

6. The solid electrolyte composition according to claim 1,
wherein the dispersion medium (C) is a hydrocarbon solvent.

7. The solid electrolyte composition according to claim 1, further comprising:
(D) a binder.

8. The solid electrolyte composition according to claim 7,
wherein the binder (D) is polymer particles having a volume-average particle diameter of 10 nm to 30 μm.

9. The solid electrolyte composition according to claim 1,
wherein the inorganic solid electrolyte having a conductivity of an ion of a metal belonging to Group I or II of the periodic table is a sulfide-based inorganic solid electrolyte (A).

10. A solid electrolyte-containing sheet comprising:
(A) an inorganic solid electrolyte having a conductivity of an ion of a metal belonging to Group I or II of the periodic table; and
(B) a fluorine-containing compound satisfying all of the following conditions b1 to b4,
b1: as constituent atoms, a carbon atom and a fluorine atom are included, but a silicon atom is not included,
b2: N_{F}/N_{ALL} that is a ratio of the number N_{F} of fluorine atoms to the number N_{ALL} of all atoms satisfies 0.10≤N_{F}/N_{ALL}≤0.80,
b3: a molecular weight is less than 5,000, which does not apply to a polymer, and
b4: a boiling point at a normal pressure or an initiation temperature of thermal decomposition at a normal pressure exceeds 100° C., and
wherein the fluorine-containing compound (B) is solid at a normal pressure and a normal temperature

11. A method for manufacturing the solid electrolyte-containing sheet according to claim 10, comprising:
a step of applying a solid electrolyte composition containing (A) the inorganic solid electrolyte having a conductivity of an ion of a metal belonging to Group I or II of the periodic table; (B) the fluorine-containing compound; and (C) a dispersion medium onto a base material; and
a step of heating and drying the solid electrolyte composition.

12. An all-solid state secondary battery comprising:
a positive electrode active material layer;
a negative electrode active material layer; and
a solid electrolyte layer,
wherein at least one layer of the positive electrode active material layer, the negative electrode active material layer, or the solid electrolyte layer is the solid electrolyte-containing sheet according to claim 10.

13. A method for manufacturing an all-solid state secondary battery, comprising:
manufacturing a solid electrolyte-containing sheet by the manufacturing method according to claim 11.
